(19) United States
(12) Patent Application Publication
(10) Pub. No.: US 2006/0165910 A1
(43) Pub. Date: Jul. 27, 2006

(54) Processes for forming nanoparticles

(75) Inventors: Toivo T. Kodas, Albuquerque, NM (US); George P. Fotou, Albuquerque, NM (US); Miodrag Oljaca, Albuquerque, NM (US); Ned Jay Hardman, Albuquerque, NM (US); Prakash Kumar, Albuquerque, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/335,726

(22) Filed: Jan. 20, 2006

Related U.S. Application Data
(60) Provisional application No. 60/645,985, filed on Jan. 21, 2005.

(51) Int. Cl. B05D 1/08; C23C 4/00

(52) U.S. Cl. 427/446; 427/258

(57) ABSTRACT

In a first aspect, the process includes utilizing a precursor medium comprising particles and a nongaseous precursor to form product nanoparticles having a core/shell structure. In another aspect, the process includes utilizing an emulsion precursor medium comprising a nongaseous precursor and two liquid vehicles, wherein one of the liquid vehicles provides desirable thermal effects upon combustion. In another aspect the flame spray process includes modifying solid particles in a flame spray process to change the phase thereof.

### CROSS REFERENCE TO RELATED APPLICATION

This application claims the benefit of U.S. Provisional Application Ser. No. 60/645,985, filed Jan. 21, 2005, the entire contents of which are incorporated herein by reference.

### FIELD OF INVENTION

The present invention relates to manufacturing nanoparticles, and more particularly, manufacturing nanoparticles in a flame spray process.

### BACKGROUND OF THE INVENTION

There is currently a heightened interest in the use of nanoparticles for a variety of applications. However, nanoparticles may range significantly in size and other properties. For example, particles ranging in size from 1 nm to 500 nm are still considered nanoparticles. For different applications, however, particle sizes or particle size distributions may vary based on product or processing requirements. Also, for some applications, certain characteristics for other properties may be desired, such as the density or morphology of the nanoparticles.

For example, in some applications it may be desirable to have smaller-size nanoparticles, while for other applications larger-size nanoparticles may be desired. Additionally, for some applications it may be preferred that the nanoparticles be spherical and unagglomerated, while in other applications it may be preferred that the nanoparticles be agglomerated, or aggregated, into larger units of aggregates with controlled structure. Also, desired properties of the nanoparticles may vary depending upon the composition of the nanoparticles.

Conventional processes for making nanoparticles have achieved some success in making nanoparticles with certain compositions and other properties. New processes are desirable, however, that provide additional and commercially viable capabilities to satisfy a need for a broader range of nanoparticulate compositions and properties.

### SUMMARY OF THE INVENTION

The present invention provides processes for forming nanoparticles through a flame spray process. In one aspect, the invention provides a flame spray process, comprising the steps of (a) providing a first precursor medium comprising a first liquid vehicle, support particles distributed in the first liquid vehicle, and a nongaseous precursor to a component; and (b) flame spraying the first precursor medium under conditions effective to form composite particles comprising the component dispersed on the support particles.

In another aspect, the invention relates to a process for forming nanoparticles, the process comprising the steps of (a) providing a precursor emulsion comprising a first liquid phase and a second liquid phase, wherein the first liquid phase comprises a first nongaseous precursor to a first component, and wherein the first and second liquid phases are not miscible in one another; and (b) flame spraying the precursor emulsion under conditions effective to form a population of nanoparticles, wherein the nanoparticles comprise the first component.

In yet another aspect, the invention relates to a flame spray process, comprising the steps of (a) providing a first precursor medium comprising a first liquid vehicle and particles of a first phase distributed in the first liquid vehicle; and (b) flame spraying the first precursor medium under conditions effective to convert the particles of the first phase to particles of a second phase.

In still another aspect, the invention relates to a method of making metal-containing nanoparticulates, the method comprising introducing into a flame reactor heated by at least one flame a nongaseous precursor including a component for inclusion in a material of the nanoparticulates, the material comprising a metal; forming the nanoparticulates, the forming comprising transferring substantially all of the component of the nongaseous precursor through a gas phase of a flowing stream in the flame reactor and growing in the flowing stream the nanoparticulates comprising the metal phase to a weight average particle size in a range having a lower limit of 1 nanometer and an upper limit of 500 nanometers.

In yet another aspect, the invention relates to the use of composite particles for the fabrication of at least a portion of a feature selected from the group consisting of a conductor, resistor, phosphor, dielectric, and a transparent conducting oxide, wherein the composite particles comprise a component dispersed on a support particle.

### BRIEF DESCRIPTION OF THE DRAWINGS

The present invention will be better understood in view of the following non-limiting figures, wherein:

FIG. 1 presents a flow diagram showing how nanoparticles and optionally nanoparticle agglomerates may be formed according to one aspect of the present invention;

FIG. 2 presents a flow diagram showing how product particles having a core/shell structure may be formed according to one aspect of the present invention;

FIG. 3 provides a cross-sectional side view of a flame reactor for use in one aspect of the invention;

FIG. 4 provides a cross-sectional side view of a flame reactor for use in another aspect of the invention;

FIG. 5 provides a cross-sectional side view of a flame reactor for use in another aspect of the invention;

FIG. 6 provides a cross-sectional side view of a flame reactor for use in another aspect of the invention;

FIG. 7 provides a cross-sectional side view of a flame reactor for use in another aspect of the invention; and

FIG. 8 provides a cross-sectional side view of a flame reactor for use in another aspect of the invention.

### DETAILED DESCRIPTION OF THE INVENTION

I. Introduction

In one aspect, the present invention is directed to a flame spray process for forming product particles, e.g., composite particles, having a core/shell structure. The process comprises the steps of: (a) providing a first precursor medium comprising a first liquid vehicle, support particles distributed in the first liquid vehicle, and a nongaseous precursor to a component; and (b) flame spraying the first precursor medium under conditions effective to form product particles, e.g., composite particles, comprising the component dispersed as nanoparticles or deposited as continuous or non-continuous layers on the support particles.

In another aspect, the invention is to a process for forming nanoparticles from a precursor emulsion. In this embodiment, the process includes the steps of: (a) providing a precursor emulsion comprising a first liquid phase and a second liquid phase, wherein the first liquid phase comprises a first nongaseous precursor to a first component, and wherein the first and second liquid phases are not miscible in one another; and (b) flame spraying the precursor emulsion under conditions effective to form a population of nanoparticles, wherein the nanoparticles comprise the first component.

In yet another aspect, the invention is to a flame spray process in which particles of a first phase are converted to particles of second phase. In this embodiment, the process comprises the steps of: (a) providing a first precursor medium comprising a first liquid vehicle and particles of a first phase distributed in the first liquid vehicle; and (b) flame spraying the first precursor medium under conditions effective to convert the particles of the first phase to particles of a second phase. Phase in this embodiment refers to the crystalline structure of the material that comprises the particles.

In one embodiment, the product particles, nanoparticles, particles of a first phase or particles of a second phase comprise particles or nanoparticles selected from the group consisting of catalyst particles, phosphor particles, and magnetic particles. In another embodiment, the product particles, nanoparticles, particles of a first phase or particles of a second phase comprise particles or nanoparticles with specific electrical properties (e.g., conductive, resistive, dielectric, etc.). In another embodiment, the processes described above further comprise the steps of: (c) collecting the product particles, nanoparticles, particles of a first phase or particles of a second phase; and (d) dispersing the product particles, nanoparticles, particles of a first phase or particles of a second phase in a liquid medium. The liquid medium may then be applied onto a surface (e.g., by ink jet printing, screen printing, intaglio printing, gravure printing, flexographic printing, and lithographic printing). The surface may, in turn, be heated to a maximum temperature below 500° C. to form at least a portion of an electronic component. For example, the surface may be heated to a maximum temperature below 500° C. to form at least a portion of a feature selected from the group consisting of a conductor, resistor, phosphor, dielectric, and a transparent conducting oxide. The feature optionally comprises a ruthenate resistor (i.e., a resistor comprising a mixed metal oxide that contains ruthenium, including, but not limited to bismuth ruthenium oxide, and strontium ruthenium oxide); a phosphor; doped zinc oxide; or a titanate dielectric.

In another embodiment, the processes described above further comprise the steps of: (c) collecting the product particles, nanoparticles, particles of a first phase or particles of a second phase; and (d) forming an electrode from the product particles, nanoparticles, particles of a first phase or particles of a second phase. The electrode may comprise a fuel cell or battery electrode. Preferably, the product particles, nanoparticles, particles of a first phase or particles of a second phase exhibit corrosion resistance. Additionally, or alternatively, the product particles, nanoparticles, particles of a first phase or particles of a second phase exhibit high temperature thermal stability and high surface area. In a preferred embodiment, the product particles maintain a surface area of at least 30 m²/g after exposure to air at 900° C. for 4 hours.

In still another embodiment, the processes described above further comprise the steps of: (c) collecting the product particles, nanoparticles, particles of a first phase or particles of a second phase; and (d) forming an optical feature from the product particles, nanoparticles, particles of a first phase or particles of a second phase. Optical features are described, for example, in co-pending U.S. Patent Application bearing Attorney Docket No. 2006A002, entitled “Security Features, Their Use, and Processes for Making Them,” filed on Jan. 13, 2006, the entirety of which is incorporated herein by reference.

In another aspect, the invention relates to a method of making metal-containing nanoparticulates, the method comprising: introducing into a flame reactor heated by at least one flame a nongaseous precursor including a component for inclusion in a material of the nanoparticulates, the material comprising a metal; forming the nanoparticulates, the forming comprising transferring substantially all of the component of the nongaseous precursor through a gas phase of a flowing stream in the flame reactor and growing in the flowing stream the nanoparticulates comprising the metal phase to a weight average particle size in a range having a lower limit of 1 nanometer and an upper limit of 500 nanometers. A special case of this is a spray matrix approach where the metal nanoparticles are occluded in a matrix of a second phase to prevent growth of the metal nanoparticles. The matrix can be a metal oxide or other ceramic material that can be later removed by selective dissolution/etching, etc.

According to processes of the present invention, a precursor medium is introduced into a flame reactor, which is a reactor having an internal reactor volume directly heated by one or more than one flame when the reactor is operated. By directly heated, it is meant that the hot discharge of a flame flows into the internal reactor volume. In the flame reactor, the precursor medium is heated in a flame under conditions effective to form product particles, e.g., nanoparticles, having desirable characteristics.

II. Precursor Medium

As indicated above, in a preferred embodiment of the present invention, a precursor medium is introduced into a flame reactor. The composition and properties of the precursor medium may vary widely depending, for example, on the composition and properties that are desired in the product particles formed by the flame spray process as well as how the precursor medium affects the operating characteristics, e.g., temperature and residence time, of the flame reactor. As used herein, “precursor medium” means a flame-sprayable composition comprising a nongaseous precursor to a component for inclusion in product particles formed by a flame spray process. Additionally, the precursor medium preferably comprises a liquid vehicle. The precursor medium optionally further comprises one or more particles (e.g., substrate particles). In some embodiments, the precursor medium may comprise one or more of the following: viscosity modifiers (e.g., methanol, ethanol, isopropanol and the like), surfactants (e.g., alkyl sulfates, alkyl sulfonates, alkyl benzene sulfates, alkyl benzene sulfonates, fatty acids, sulfosuccinates, phosphates, and the like), emulsifiers (e.g., monoglycerides, polysaccharides, sorbitan trioleate, tall oil esters, polyoxyethylene ethers, and the like) or stabilizers (e.g., polyvinyl pyrrolidone, poly(propylenoxide) amines, polyamines, polyalcohols, polyoxides, polyethers, polyacrylamides, polyacrylates, and the like). In some aspects of the invention, the precursor medium includes a liquid nongaseous precursor to a component and particles, but not a liquid vehicle.

The liquid vehicle optionally includes one or more than one of any of the following liquid phases: organic, aqueous, and/or organic/aqueous mixtures. Some nonlimiting examples of organic liquids that may be included in the liquid vehicle include alcohols (e.g., methanol, ethanol, isopropanol, butanol), organic acids, glycols, aldehydes, ketones, ethers, aromatics (e.g., toluene and xylene), alkanes (e.g., hexane and isooctane), waxes, or fuel oils (e.g., stoddard, kerosene or diesel oil). In addition to or instead of the organic liquid, the liquid vehicle may include an inorganic liquid, which will, in some embodiments, be aqueous-based. Some nonlimiting examples of such inorganic liquids include aqueous solutions, which may be pH neutral, acidic or basic. A precursor medium, from which droplets are generated, may include a mixture of mutually soluble liquid components, or the precursor medium may contain multiple distinct liquid phases (e.g., an emulsion). Thus, the precursor medium may be a mixture of two or more mutually soluble liquid components. For example, the liquid vehicle may comprise a mixture of mutually soluble organic liquids or a mixture of water with one or more organic liquids that are mutually soluble with water (e.g., some alcohols, ethers, ketones, aldehydes, etc.). The precursor medium may also include multiple liquid phases, such as in an emulsion. For example, precursor medium could include an oil-in-water or a water-in-oil emulsion. In addition to multiple liquid phases, the precursor medium, and the droplets formed therefrom, may include multiple liquid phases and one or more solid phases (i.e., suspended particles). As one example, the precursor medium, and the droplets formed therefrom, may include an aqueous phase, an organic phase and a solid particle phase. As another example, the precursor medium, and the droplets formed therefrom, may include an organic phase, particles of a first composition and particles of a second composition.

Moreover, a liquid vehicle, or component thereof, in the precursor medium may have a variety of functions. For example, a liquid the vehicle may be a solvent for the nongaseous precursor, and the nongaseous precursor may be dissolved in the liquid vehicle when introduced into the flame reactor. As another example, the liquid vehicle may be or may include a component that is a fuel or an oxidant for combustion in a flame of the flame reactor or a propellant (e.g., liquid propane or supercritical CO₂) for dispersion of liquid. Such fuel or oxidant in the precursor medium may be the primary or a supplemental fuel or oxidant for driving the combustion in a flame. The liquid vehicle may provide one or more of any of these or other functions, e.g., the liquid vehicle may provide a supplemental fuel, such as one of the fuels described above. A supplemental fuel may be required in some cases where the precursor medium has a low enthalpy of combustion. The supplemental fuel provides sufficient heat to completely evaporate the atomized precursor medium droplets and convert them completely to product particles.

In one embodiment, the precursor medium further comprises particles, e.g., support or substrate particles. In this aspect, the particles from the precursor medium may form the core (or a substantial portion of the core) of composite particles formed by the process of the present invention. As used herein, the term “particles,” without modification, refers to the particles contained in the precursor medium that is introduced in the flame reactor rather than the product particles, e.g., composite particles, formed by the flame spray process. In this embodiment, the precursor to the component forms the component on the support particles (e.g., as nanoparticles or as layer) to form product particles having a core/shell structure.

In one embodiment of the core/shell aspect of the invention, the component that is formed by flame spraying the precursor medium coats the entire surface of the particles, thereby forming a solid shell around the particles. In another embodiment of the core/shell aspect of the invention, the component that is formed by flame spraying the precursor medium decorates the surface of the support particle, such that part of, if not the entire surface of the support particle is covered with finely dispersed nanoparticles of the component (e.g., a noble metal dispersed on a high surface area metal oxide core particle).

In yet another embodiment, the support particle functions as a matrix or support structure. The component that is formed by flame spraying the precursor medium may then be distributed uniformly within this matrix to form product particles that comprise two phases where the component is uniformly distributed throughout the support particle (e.g., SiO₂:TiO₂). In still another embodiment, the component that is formed by flame spraying the precursor medium may combine with the support particle (e.g., dissolve in the support particle) to form a product particle that has a single phase (e.g., SiO₂:Al₂O₃ and CeO₂:ZrO₂). In yet another embodiment, the first precursor medium, rather than forming distinct particles or layers on the support particles, forms a matrix that functions as a spacer between support particles. The product particles, therefore, comprise a plurality of support particles separated from each other but “trapped” inside a second phase which is the reaction product of the precursor in the first precursor medium.

It is contemplated that the particles from the precursor medium may agglomerate during flame spraying to form an aggregated structure that forms the core or a substantial portion of the core of the composite particles. In this aspect, the core comprises a plurality of particles derived from the precursor medium. The component formed from the nongaseous precursor may also be present in the core, e.g., interspersed in the interstitial spaces formed as the particles agglomerate, of the product particles formed according to this aspect of the invention.

The particles in the precursor medium may be nanoparticles. In some instances, however, the particles in the precursor medium can be from about 5 to 20 microns. The particles in the precursor medium are preferably less than about 1 micron in size. As used herein, the term “nanoparticles,” means particles having a weight average particle size (d50 value) of about 500 nm or smaller. In one embodiment, the nanoparticles have a d50 value of about 100 nm or smaller.

The product particles produced using the processes described herein can have a variety of morphologies, e.g., solid spherical particles of one component decorated with nanoparticles of different component, solid particles with different levels of agglomeration, fractal-like aggregates of support particles decorated or coated with nanoparticles of a different component, or particles with hierarchical structure spanning nanometer to micron size ranges.

In some embodiments, the support particles can be fibers. This morphology offers many advantages, e.g., low pressure drop when these particles are packed in a chromatographic column used for bioseparations. Fibers, however, usually have a very low surface area which limits their applications. The processes of the invention, however, allow coating of low surface area fibers with nanoparticles that enhance the surface area of the former. Similarly, surface enhancement can be achieved for other structures, e.g., dense or hollow micron-sized support particles.

As indicated above, the precursor medium includes a nongaseous precursor to a component for inclusion in the nanoparticles formed by the flame spray process. By “component” it is meant at least some identifiable portion of the nongaseous precursor that becomes a part of the composite particles. For example, the component could be the entire composition of the nongaseous precursor when that entire composition is included in the composite particles. More often, however, the component will be something less than the entire composition of the nongaseous precursor, and may be only a constituent element present in both the composition of the nongaseous precursor and the nanoparticles. For example, it may be the case that in the flame reactor the nongaseous precursor decomposes, and one or more than one element in a decomposition product then becomes part of the product particles, either with or without further reaction of the decomposition product.

In a preferred implementation, the precursor medium, comprising the nongaseous precursor and a liquid vehicle, may also contain suspended solids or particulates. Some nonlimiting examples of classes of materials that may be used as the nongaseous precursor include: nitrates, oxalates, acetates, acetyl acetonates, carbonates, carboxylates, acrylates and chlorides. Other examples of nongaseous precursors to a component for inclusion in the nanoparticles are disclosed in U.S. patent application Ser. Nos. 11/199,512 and 11/199,100, both of which were filed Aug. 8, 2005, and the entireties of which are each incorporated herein by reference.

III. Flame Reactor Operation

A. Introduction of Precursor Medium into Flame Reactor

The precursor medium may be introduced into the flame reactor in any convenient way. By being introduced into the flame reactor, it is meant that the precursor medium is either introduced into one or more than one flame of the reactor (i.e., delivered as feed to the flame) or introduced into a hot zone in the internal reactor volume directly heated by one or more than one flame.

In a preferred embodiment, the precursor medium is atomized and introduced into the flame reactor as a nongaseous disperse phase. The disperse phase may be, for example, in the form of droplets. The term “droplet” used in reference to such a disperse phase refers to a disperse domain characterized as including liquid (often the droplet is formed solely or predominantly of liquid, although the droplet may comprise multiple liquid, phases and/or particles suspended in the liquid). The term “particle” used in reference to such a disperse phase refers to a disperse domain characterized as being solid. The droplets preferably have a composition substantially similar to that of the precursor medium from which they were formed.

As noted above, in one embodiment, the disperse phase droplets may comprise particles suspended in the droplets. Such suspended particles preferably act as nucleates. Preferably, the support particles are not soluble to any significant extent in any liquid components contained in the precursor medium.

When the precursor medium is introduced into the flame reactor in a disperse phase, as discussed above, in one preferred embodiment the disperse phase is dispersed in a gas phase. The gas phase may include any combination of gaseous components in any concentrations. The gas phase may include only components that are inert (i.e. nonreactive) in the flame reactor or the gas phase may comprise one or more reactive components (i.e., decompose or otherwise react in the flame reactor with oxidants like O₂, CO and the like or with fuels like light alkanes, hydrogen, and the like). When the nongaseous precursor is fed to a flame, the gas phase may comprise a gaseous fuel and/or oxidant for combustion in the flame. A nonlimiting example of a gaseous oxidant is gaseous oxygen, which could be provided by making the gas phase from or including air. A nonlimiting example of another possible gaseous oxidant is carbon monoxide. Nonlimiting examples of gaseous fuels that could be included in the gas phase include hydrogen gas and gaseous organics, such as for example C₁-C_{y} hydrocarbons (e.g., methane, ethane, propane, butane). In one embodiment, the gas phase includes an oxidant (normally oxygen in air), and fuel is delivered separately to the flame. Alternatively, the gas phase may include both fuel and oxidant premixed for combustion in a flame. Optionally, the gas phase includes a gas mixture containing more than one oxidant and/or more than one fuel. The gas phase includes one or more than one gaseous precursor for a material of the nanoparticles. Such a gaseous precursor(s) would be in addition to the nongaseous precursor in the disperse phase that is derived from the precursor medium (e.g., volatile precursors such as SiCl₄, TiCl₄, and other halides). The component provided by a gaseous precursor for inclusion in the nanoparticles may be the same or different than the component provided by the nongaseous precursor. One situation when the gas phase includes a gaseous precursor is when making nanoparticles that include an oxide material, and the gaseous precursor is oxygen gas. Sufficient oxygen gas should be included, however, to provide excess over that consumed by combustion when the nongaseous precursor is fed to the flame. Moreover, the gas phase may include any other gaseous component that is not inconsistent with manufacture of the desired nanoparticles, or that serves some function other than those noted above (e.g., cooling, dilution, etc).

In one embodiment, the disperse phase of the flowing stream includes a liquid vehicle, the liquid vehicle containing the dissolved nongaseous precursor, which includes or forms the component for inclusion in the nanoparticles. In this embodiment, the generating step includes steps for dispersing the liquid vehicle into droplets within the gas phase. This may be performed using any suitable device that disperses liquid into droplets, such as for example, a spray nozzle. The spray nozzle may be any spray nozzle which is useful for dispersing liquids into droplets. Some examples include ultrasonic spray nozzles, multi-fluid spray nozzles and pressurized spray nozzles.

Ultrasonic spray nozzles generate droplets of liquid by using piezoelectric materials that vibrate at ultrasonic frequencies to break up a liquid into small droplets. Pressurized nozzles use pressure and a separator or screen in order to break up the liquid into droplets. In some cases, pressurized nozzles may involve use of some vapor that is generated from the liquid itself in order to pressurize and break up the liquid into droplets. One advantage of using ultrasonic and pressurized nozzles is that an additional fluid is not required to generate liquid droplets. This may be useful in situations where the nongaseous precursor dissolved in the liquid is sensitive and/or incompatible with other common fluids used in multi-fluid spray nozzles.

In addition to the use of a spray nozzle for dispersing the liquid medium, any other suitable device or apparatus for generating disperse droplets of liquid may be used in the generating step. One example of a device that is useful in generating droplets of liquid is an ultrasonic generator. An ultrasonic generator uses transducers to vibrate liquids at very high frequencies which break up the liquid into droplets. One example of an ultrasonic generator that is useful with the present invention is disclosed in U.S. Pat. No. 6,338,809, incorporated herein by reference in its entirety. Another example of a device that is useful in generating droplets of liquid is a high energy atomizer such as those used in carbon black production.

B. Flame Formation and Control

Upon its introduction into the flame reactor, preferably as a disperse phase, a component in the precursor medium, e.g., the liquid vehicle, acts as a fuel and burns in an oxidizing environment to form a flame. In various aspects of the invention, the flame reactor includes one or more than one flame that directly heats an interior reactor volume. Each flame of the flame reactor will be generated by a burner, through which oxidant and the fuel (e.g., the liquid vehicle) are fed to the flame for combustion. The burner may be of any suitable design for use in generating a flame, although the geometry and other properties of the flame will be influenced by the burner design. Some exemplary burner designs that may be used to generate a flame for the flame reactor are discussed in detail in U.S. Provisional Patent Application No. 60/645,985, filed Jan. 21, 2005, the entirety of which is incorporated herein by reference. Each flame of the flame reactor may be oriented in any desired way. Some nonlimiting examples of orientations for the flame include horizontally extending, vertically extending or extending at some intermediate angle between vertical and horizontal. When the flame reactor has a plurality of flames, some or all of the flames may have the same or different orientations.

Each flame has a variety of properties (e.g., flame geometry, temperature profile, flame uniformity, flame stability), which are influenced by factors such as the burner design, properties of feeds to the burner, and the geometry of the enclosure in which the flame is situated.

One important aspect of a flame is its geometry, or the shape of the flame. Some geometries tend to provide more uniform flame characteristics, which promote manufacture of product particles having relatively uniform properties at high production rates (e.g., at 1 kg/h). One geometric parameter of the flame is its cross-sectional shape at the base of the flame perpendicular to the direction of flow through the flame. This cross-sectional shape is largely influenced by the burner design, although the shape may also be influenced by other factors, such as the geometry of the enclosure and fluid flows in and around the flame. Other geometric parameters include the length and width characteristics of the flame. In this context the flame length refers to the longest dimension of the flame longitudinally in the direction of flow (e.g., the distance from the burner tip to the flame apex) and flame width refers to the longest dimension across the flame perpendicular to the direction of flow. With respect to flame length and width, a wider, larger cross sectional area flame, has potential for more uniform temperatures across the flame, because edge effects at the perimeter of the flame are reduced relative to the total area of the flame. The area to volume ratio of the flame determines how fast the flame is quenched. A higher area to volume ratio flame cools off faster. Burner geometry, burner configuration and burner shape, in combination with the flame stoichiometry (e.g., whether the flame is fuel rich, oxidant rich or is burning a stoichiometric amount of oxidant), influence the stability and shape of the flame. The stability of the flame, in turn, influences the product particle properties (e.g., particle size distribution, morphology and phase composition) and their uniformity (e.g., uniformity of distribution of a component on particles).

Discharge from each flame of the flame reactor flows through a flow path, or the interior pathway of a conduit, defining the flame reactor. As used herein, “conduit” refers to a confined passage for conveyance of fluid through the flame reactor. When the flame reactor comprises multiple flames, discharge from any given flame may flow into a separate conduit for that flame or a common conduit for discharge from more than one of the flames. Ultimately, however, streams flowing from each of the flames preferably combine in a single conduit prior to discharge from the flame reactor.

A conduit defining the flame reactor may have a variety of cross-sectional shapes and areas available for fluid flow, with some nonlimiting examples including circular, elliptical, square or rectangular. In most instances, however, conduits having a circular cross-section are preferred. The presence of sharp corners or angles may create unwanted currents, flow disturbances and recirculation zones that can cause deposition on conduit surfaces and disturb the flame. Walls of the conduit may be made of any material suitable to withstand the temperature and pressure conditions within the flame reactor. The nature of the fluids flowing through the flame reactor may also affect the choice of materials of construction used at any location within the flame reactor. Temperature, however, may be the most important variable affecting the choice of conduit wall material. For example, quartz may be a suitable material for temperatures up to about 1200° C. As another example, for temperatures up to about 1500° C., possible materials for the conduit include refractory materials such as alumina, mullite or silicon carbide. As yet another example, for processing temperatures up to about 1700° C., graphite or graphitized ceramic might be used for conduit material. As another example, if the flame reactor will be at moderately high temperatures, but will be subjected to highly corrosive fluids, the conduit may be made of a stainless steel material or a high nickel alloy material (e.g., hastelloy, inconel, incoloy, etc.). These are merely some illustrative examples. The wall material for any conduit portion through any position of the flame reactor may be made from any suitable material for the processing conditions. Other examples of materials from which a flame reactor may be made include water-cooled or air-cooled jacketed heat exchangers with an internal wall made of glass or metal (e.g., stainless steel, carbon steel, aluminum, high nickel alloys, and the like).

The precursor medium is preferably introduced into the flame reactor in a very hot zone, also referred to herein as a primary zone, that is sufficiently hot to cause the component of the nongaseous precursor for inclusion in the nanoparticles to be transferred through the gas phase of a flowing stream in the flame reactor, followed by particle nucleation from the gas phase. Preferably, the temperature in at least some portion of this primary zone, and sometimes only in the hottest part of the flame, is high enough so that substantially all of materials flowing through that portion of the primary zone is in the gas phase. The component of the nongaseous precursor may enter the gas phase by any mechanism. For example, the nongaseous precursor may simply vaporize, or the nongaseous precursor may decompose and the component for inclusion in the product particles enters the gas phase as part of a decomposition product. Eventually, however, the component then leaves the gas phase as particle nucleation and growth occurs. Removal of the component from the gas phase may involve simple condensation as the temperature cools or may include additional reactions involving the component that results in a non-vapor reaction product. Remaining vaporized precursor may react on the surface of the already nucleated monomers by surface reaction mechanism. The monomers grow further to form primary particles by coagulation and instantaneous coalescence. As the temperature cools, coalescence rates decrease relative to coagulation and particles do not instantaneously coalesce. Instead, the particles partially fuse together to form aggregates.

In addition to this primary zone where the component of the nongaseous precursor is transferred into the gas phase, the flame reactor may also include one or more subsequent zones for growth or modification of the nanoparticles. In most instances, the primary zone will be the hottest portion within the flame reactor.

In addition to the shape of the flame(s), which may help control temperature profiles, it is also possible to control the feeds introduced into a burner. One example of an important control is the ratio of fuel (e.g., liquid vehicle) to oxidant that is fed into a flame. In some embodiments, the precursors introduced into a flame may be easily oxidized, and it may be desirable to maintain the fuel to oxidant ratio at a fuel rich ratio to ensure that no excess oxygen is introduced into the flame. Some materials that are preferably made in a flame that is fuel rich include materials such as metals, nitrides, and carbides. The fuel rich environment ensures that all of the oxygen that is introduced into a flame will be combusted and there will be no excess oxygen available in the flame reactor to oxidize the nanoparticles or precursors. In other words, there is a stoichiometric amount of oxygen in the feed that promotes the complete combustion of all the fuel present, thereby leaving no excess oxygen. In other embodiments, it may be desirable to have a fuel to oxidant ratio that is rich in oxygen. For example, when making metal oxide ceramics, it may be desirable to maintain the environment within a flame and in the flame reactor with excess oxygen. In yet other embodiments, the fuel to oxygen ratio introduced into the flame may not be an important consideration in processing the nanoparticles. In yet another embodiment, the flame is fuel-rich in order to produce a carbonaceous component in the particles that may be desirable for various reasons (e.g., conductivity and carbon matrix that can be removed by burning off).

In addition to the environment within the flame and the flame reactor, the fuel to oxidant ratio also controls other aspects of the flame. One particular aspect that is controlled by the flame is the flame temperature. If the fuel to oxidant ratio is at a fuel rich ratio then the flame reactor will contain fuel that is uncombusted. Unreacted fuel generates a flame that is at a lower temperature than if all of the fuel that is provided to the flame reactor is combusted. Uncombusted fuel will introduce carbon contamination in the product particles. Thus, in those situations in which it is desirable to have all of the fuel combusted in order to maintain the temperature of a flame at a high temperature, it will be desirable to provide to the flame reactor excess oxidant to ensure that all of the fuel provided to the flame or flame reactor is combusted. However, if it is desirable to maintain the temperature of the flame at a lower temperature, then the fuel to oxidant ratio may be fuel rich so that only an amount of fuel is combusted so that the flame does not exceed a desired temperature. The same effect can be obtained by using excess oxygen. The maximum flame temperature is obtained when the stoichiometric amount of oxygen is used. Excess oxygen will result in lower flame temperatures.

The total amount of fuel and oxidant fed into the flame determines the velocity of the combusted gases, which, in turn, controls the residence time of the primary particles formed in the flame. The residence time in the flame of the primary particles determine the product particle size and in some cases the morphology of the product particles. The relative ratio of oxygen to fuel also determines the concentration of particles in the flame which, in turn, determines the final product particle size and morphology. More dilute flames will make smaller or less aggregated particles.

The specific type of fuel will also affect the temperature of a flame. In addition to the temperature of the flame, the selection of a fuel may involve other considerations. Fuels that are used to combust and create the flame may be gaseous or nongaseous. The nongaseous fuels may be a liquid, solid or a combination of the two. In some cases, the fuel combusted to form the flame may also function as a solvent for the nongaseous precursor. For example, a liquid fuel may be used to dissolve a nongaseous precursor and be fed into a burner as dispersed droplets of the precursor medium containing the dissolved nongaseous precursor. The advantage of this is that the precursor is surrounded by fuel in each droplet which upon combustion provides optimum conditions for precursor conversion. In other embodiments, the liquid fuel may be useful as a solvent for the precursor but not contain enough energy to generate the required heat within the flame reactor for all of the necessary reactions. In this case, the liquid fuel may be supplemented with another liquid fuel and/or a gaseous fuel, which are combusted to contribute additional heat to the flame reactor. Nonlimiting examples of gaseous fuels that may be used with the method of the present invention include methane, propane, butane, hydrogen and acetylene. Some nonlimiting examples of liquid fuels that may be used with the method of the present invention include alcohols, toluene, acetone, isooctane, acids and heavier hydrocarbons such as kerosene and diesel oil.

One criterion that may be employed for the selection of gaseous and nongaseous fuels is the enthalpy of combustion of the fuel. The enthalpy of combustion of a fuel determines the temperature of the flame, the associated flame speed (which affects flame stability) and the ability of the fuel to burn cleanly without forming carbon particles. In addition, when the fuel is a liquid fuel, it is preferred that the nongaseous precursor is miscible in the liquid fuel.

As noted above, in some cases the fuel (e.g., the liquid vehicle) will be a combination of liquids. This embodiment is useful in situations when it is desirable to dissolve the nongaseous precursor into a liquid to disperse the nongaseous precursor. However, the nongaseous precursor may only be soluble in liquids that are low energy fuels. In this case, the low energy fuel (e.g., the liquid vehicle) may be used to dissolve the nongaseous precursor, while an additional higher energy fuel may supplement the low energy fuel to generate the necessary heat within the flame reactor. In some instances, the two liquid fuels may not be completely soluble in one another, in which case the liquid will be a multiphase liquid with two phases (i.e., an emulsion). Alternatively, the two liquid fuels may be introduced separately into the flame from separate conduits (e.g., in a multi-fluid nozzle case). In other instances the two liquids may be mutually soluble in each other and form a single phase. It should be noted that in other cases there may be more than two liquid fuels introduced into the flame, the liquids may be completely soluble in one another or may be in the form of an emulsion. It should also be noted that the nongaseous precursor that is introduced into the flame reactor may also, in addition to containing the component for inclusion in the nanoparticles, act as a fuel and combust to generate heat within the flame reactor.

The oxidant used in the method of the present invention to combust with the fuel to form the flame may be a gaseous oxidant or a nongaseous oxidant. The nongaseous oxidant may be a liquid, a solid or a combination of the two. However, preferably the oxidant is a gaseous oxidant and will optionally comprise oxygen. The oxygen may be introduced into the flame reactor substantially free of other gases such as a stream of substantially pure oxygen gas. In other cases, the oxygen will be introduced into the flame reactor with a mixture of other gases such as nitrogen, as is the case when using air. Although it is preferable to have a gaseous oxidant, in some cases the oxidant may be a liquid. Some examples of liquids that may be used as oxidants include inorganic acids. Also, the oxidant that is introduced into the flame reactor may be a combination of a gaseous oxidant or a liquid oxidant. This may be the case when it is desirable to have the nongaseous precursor dissolved in a liquid to disperse it, and it also desirable to have the oxidant located very close to the nongaseous precursor when in the flame reactor. In this case, the precursor may be dissolved in a liquid solvent that functions as an oxidant.

As indicated above, in another aspect of the invention, the invention is to a process for forming nanoparticles from a precursor emulsion. In this embodiment, the process includes the steps of: (a) providing a precursor emulsion comprising a first liquid phase and a second liquid phase, wherein the first liquid phase comprises a first nongaseous precursor to a first component, and wherein the first and second liquid phases are not miscible in one another; and (b) flame spraying the precursor emulsion under conditions effective to form a population of nanoparticles, wherein the nanoparticles comprise the first component. By “not miscible in one another” it is meant that the components will separate into distinct phases when combined. With the aid of an emulsifying agent, the two (or more) immiscible liquid phases can be made into an emulsion and used in the processes described herein. The emulsifying agent can comprise the entire first or second liquid phases or can be an additive to the first and/or second liquid phases. It is possible to have any phase ratio in an emulsified system.

The invention provides significantly higher conversions than were conventionally possible. For example, at least 90 weight percent, at least about 95 weight percent or at least about 97 weight percent of the first nongaseous precursor to the first component in the first liquid phase may be converted to the first component in the nanoparticles.

The first liquid phase preferably further comprises a first liquid vehicle, as described in detail above. Additionally or alternatively, the second liquid phase comprises a second liquid vehicle. The second liquid vehicle may be any of the liquid vehicles described above so long as the second liquid phase remains immiscible with the first liquid phase, as described above. In one embodiment the first liquid phase comprises an organic liquid, while the second liquid phase comprises water. In a preferred embodiment, the first liquid phase comprises Stoddard, kerosene, toluene, or isooctane and the second liquid phase comprises water.

In various aspects, the first liquid vehicle has a first boiling point and the second liquid vehicle has a second boiling point, and wherein the absolute value of the difference between the first boiling point and the second boiling point is from about 10° C. to about 300° C., e.g., from about 50° C. to about 30° C. or from about 150° C. to about 300° C. The volume ratio of the first liquid vehicle to the second liquid vehicle ranges from about 1% to about 99%, e.g., from about 20% to about 80% or from about 30% to about 60%.

In this aspect of the invention, the second liquid phase preferably is selected for some property that affects the formation of the product particles in a desirable way. For example, the second liquid phase may have a higher or lower enthalpy (heat) of combustion than the first liquid phase. If the first liquid phase has an undesirably low enthalpy of combustion, it may be desirable to couple the first liquid phase with a second liquid phase having a higher enthalpy of combustion. Conversely, if the first liquid phase has an undesirably high enthalpy of combustion, it may be desirable to couple the first liquid phase with a second liquid phase having a lower enthalpy of combustion. Thus, the first liquid vehicle optionally has a first enthalpy of combustion and the second liquid vehicle has a second enthalpy of combustion, which is less than the first enthalpy of combustion. Alternatively, the first liquid vehicle has a first enthalpy of combustion and the second liquid vehicle has a second enthalpy of combustion, which is greater than the first enthalpy of combustion. As used herein, the term “enthalpy of combustion” means the energy released per unit mass from the combustion of the material with stoichiometric amounts of oxygen.

In various aspects of the invention the second liquid phase may or may not include a nongaseous precursor. Thus, the second liquid phase may optionally further comprise a second nongaseous precursor (in liquid or solid form) to a second component. In this aspect, the nanoparticles formed by the process comprise the first component and the second component. The nanoparticles may comprise a homogenous mixture of the first component and the second component, a heterogeneous mixture of the first component and a second component, a core/shell structure, or a composite structure where a first component forms a primary particle and the second component forms a second primary particle, thereby forming a nanoparticle where the two different primary particles that are joined, but are not mixed together.

Conditions that promote the formation of nanoparticles comprising a homogeneous mixture of the first component and the second component include, inter alia, intimate mixing of nongaseous precursors prior to their introduction into the flame reactor; similar boiling points, reaction rates and vapor pressures of the nongaseous precursors so that the first component and the second component form at about the same time; and similarity in the volatility/vapor pressure of the first component and the second component.

Conditions that promote the formation of nanoparticles comprising a heterogeneous mixture of the first component and the second component include, inter alia, non-intimate mixing of nongaseous precursors prior to their introduction into the flame reactor; dissimilar boiling points, reaction rates and vapor pressures of the nongaseous precursors so that the fist component and the second component form at about the same time; and a dissimilarity in the volatility/vapor pressure of the first component and the second component.

Conditions that promote the formation of nanoparticles with a core/shell structure include, inter alia, the introduction of one nongaseous precursor at the flame and the introduction of a second nongaseous precursor at a point located after the flame in the flame reactor; and dissimilarity in the vapor pressures of the nongaseous precursors so that one component tends to migrate toward the outside of the nanoparticle to form the shell, while the other component remains in the core.

Conditions that promote the formation of nanoparticles with a composite structure include, inter alia, the relative concentration of the first nongaseous precursor to the second nongaseous precursor; solubility of the first nongaseous precursor in the second nongaseous precursor; and the solubility of the first component in the second component.

If the second liquid phase includes a nongaseous precursor, the component formed from the nongaseous precursor may be the same or different from the nongaseous precursor present in the first liquid phase. The second liquid vehicle may be any of the liquid vehicles described above so long as the second liquid phase remains immiscible with the first liquid phase, as described above.

In another aspect, the second liquid phase includes a nongaseous precursor, which works in conjunction with a different nongaseous precursor in the first liquid phase to form a single component in the ultimately formed product particles.

One desirable aspect of utilizing a precursor emulsion in a flame spray process is that it provides the ability to control certain product particle characteristics. For example, certain emulsion precursors processed under certain conditions may form hollow nanoparticles. Generally, the use of relatively low boiling point liquid vehicles and low flame temperatures, in combination, favor hollow particle formation. Hollow particle formation is also favored when the evaporation rate of the liquid vehicle is greater than the reaction rate of the nongaseous precursor.

Conventional processes for forming nanoparticles from non-volatile precursors have not been able to form such narrow particle distributions. In particular, conventional processes for forming nanoparticles form undesirably large particles (e.g., on the order of greater than 1 μm) in addition to smaller nanoparticles in a bimodal particle size distribution. Such conventional processes require separation of the larger particles in order to provide a commercially useful population of desirably sized product particles, e.g., nanoparticles. The present processes, however, provide the ability to form a population of product nanoparticles that, as formed, comprise less than about 5 volume percent, less than about 3 volume percent, or less than about 2 volume percent particles having a particle size greater than 1 μm.

The flame spray processes of the present invention provide several additional benefits. For example, the processes desirably provide the ability to continuously manufacture product particles. In various aspects, the flame spraying step occurs continuously for at least 4 hours, at least about 8 hours, at least about 12 hours or at least about 16 hours per day.

The process also provides the ability to manufacture commercially valuable product particles at a fast rate. For example, the process optionally forms nanoparticles at a rate of at least about 0.1 kg/hr, at least about 1 kg/hr, at least about 1.5 kg/hr, at least about 2.0 kg/hr or at least about 10.0 kg/hr.

C. Flame Reactor Design and Process Parameters

Desirably, the flame spray processes of the present invention, and particularly the flame spraying steps thereof, occur in an enclosed flame spray system. As used herein, an “enclosed” flame spray system is a flame spray system that separates the flame from the surroundings and enables controlled input of, e.g., fuel/oxidant, nongaseous precursors and liquid vehicle, such that the process is metered and is precisely controlled.

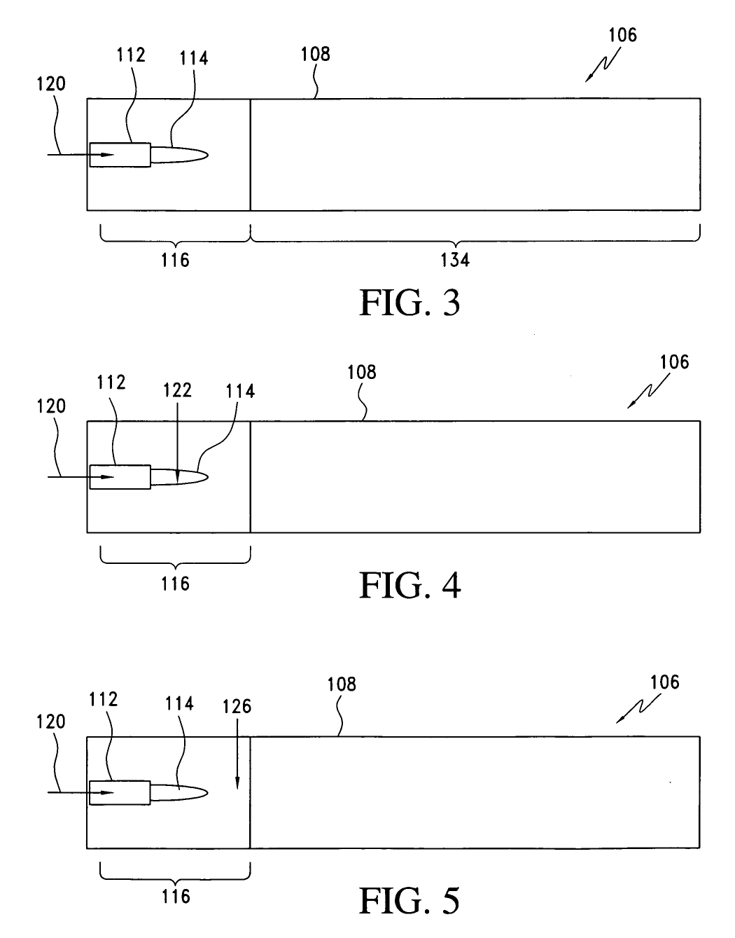

With reference to FIG. 3, one embodiment of a flame reactor that may be used with the method of the present invention is shown. FIG. 3 is a cross-sectional view of a flame reactor 106. Flame reactor 106 includes a tubular conduit 108 of a circular cross-section, a burner 112, and a flame 114 generated by the burner 112. In the embodiment of FIG. 3, flame 114 is disposed within tubular conduit 108. Flame reactor 106 has a very hot primary zone 116 that includes the flame 114 and the internal reactor volume within the immediate vicinity of the flame.

Also, shown in FIG. 3, feed 120, which includes the precursor medium, is introduced directly into the flame 114 through the burner 112. Fuel and oxidant for the flame 114 may be fed to the flame 114 as part of and/or separate from the feed 120 of the nongaseous precursor. In a preferred embodiment, the liquid vehicle preferably present in the precursor medium acts as the fuel.

FIGS. 4 and 5 show the same flame reactor 106, except with feed of the nongaseous precursor introduced into the primary zone 116 in different locations. In FIG. 4, feed of nongaseous precursor 122 is introduced in the primary zone 116 directed toward the end of the flame 114, rather than through the burner 112 as with FIG. 3. In FIG. 5, feed of nongaseous precursor 126 is introduced into the primary zone 116 at a location adjacent to, but just beyond the end of the flame 114.

FIGS. 3-5 are only examples of how precursor mediums may be introduced into a flame reactor. Additionally multiple feeds of precursor medium may be introduced into the flame reactor 106, with different feeds being introduced at different locations, such as simultaneous introduction of the feeds 120, 122 and 126 of FIGS. 3-5.

To form the desired product particles (e.g., nanoparticles), which include the component from the nongaseous precursor in the precursor medium, the component is transferred through the gas phase in the flowing stream in the flame reactor. Following nucleation of the particles, the particles then grow to the desired size by coagulation and coalescence.

During the step of transferring of the component through the gas phase, the component of the nongaseous precursor, and optionally all other material (if any) of the nongaseous precursor, enters the gas phase in a vapor form. The transfer into the gas phase is driven by the high temperature in the flame reactor in the vicinity of where the nongaseous precursor is introduced into the flame reactor. As previously noted, this may occur by any mechanism which may include simple vaporization of the nongaseous precursor or thermal decomposition or other reaction involving the nongaseous precursor. The transferring step also includes removing the component from the gas phase, to permit inclusion in the nanoparticles. Removal of the nongaseous precursor from the gas phase may likewise involve a variety of mechanisms, including simple condensation as the temperature of the flowing stream drops, or a reaction producing a non-volatile reaction product. Also, it is noted that transfer into and out of the gas phase are not necessarily distinct steps, but may be occurring simultaneously, so that some of the component may still be transferring into the gas phase where other of the component is already transferring out of the gas phase. Regardless of mechanism, however, substantially all of the component from the nongaseous precursor is transferred through the gas phase.

In one aspect, the nongaseous precursor may be a solid material that includes the component. The temperature in the flame reactor may be above the boiling point or sublimation temperature of the solid material. Consequently, the transferring of the component through the gas phase may involve simple vaporization of liquid medium in order to cause the solid material to flow through the flame reactor. Examples include AlCl₃ and ZrCl₄; both solids at room temperature but with relatively high vapor pressure and low sublimation temperatures (<300° C.). Additionally or alternatively, the transferring of the component through the gas phase may involve simple vaporization of a solid nongaseous precursor in order to cause the solid material to flow through the flame reactor. In one specific example, the precursor may be a solid or liquid metal or metal oxide, and the metal is the component for inclusion in the nanoparticles. In the flame reactor the metal (metal oxide) may then vaporize in the high temperature zone of the flame reactor following introduction and then condense out as the stream cools. The temperature in the flame reactor may be above the boiling point of metal or metal oxide, so that the metal introduced as a solid in the flowing stream will boil and be included in the gas phase as metal vapor, prior to being included in the nanoparticles. Thus, the transferring step may merely involve boiling or vaporizing a solid precursor into a vapor. In another example, a solid or liquid precursor including the component may react or decompose to form a reaction product, either a vapor-phase material or one that is vaporized following formation.

Also, substantially all material in a feed stream of the nongaseous precursor should in one way or another be transferred into the gas phase during the transferring step. For example, one common situation is for the feed to include droplets in which the nongaseous precursor is dissolved when introduced into the flame reactor. In this situation, liquid in the droplet must be removed as well. The liquid may simply be vaporized to the gas phase, which would be the case for water. Also, some or all of the liquid may be reacted to vapor phase products. As one example, when the liquid contains fuel or oxidant that is consumed by combustion in a flame in the reactor, any solid fuel or oxidant in the feed may also be consumed and converted to gaseous combustion products. In some cases, however, the particles, when present, will not be transferred into the gas phase.

As indicated above, the particles formed during the transferring step may be grown to a desired size and morphology through controlled agglomeration. During the growing step, the nanoparticles are controllably grown to increase the weight average particle size of the nanoparticles into a desired weight average particle size range, which will depend upon the particular composition of the nanoparticles and the particular application for which the nanoparticles are being made.

The growing step commences with particle nucleation and continues until the nanoparticles attain a weight average primary particle size within a desired range. When making extremely small particles, the growing step may mostly or entirely occur within the primary zone of the flame reactor immediately after the flame. However, when larger particle sizes are desired, processing may be required in addition to that occurring in the primary zone of the flame reactor. As used herein, “growing” the nanoparticles refers to increasing the weight average particle size of the nanoparticles. Such growth may occur due to collision and agglomeration and sintering of smaller particles into larger particles or through addition of additional material into the flame reactor for addition to the growing nanoparticles. The growth of the nanoparticles may involve added material of the same type as that already present in the nanoparticles or addition of a different material. Depending on the temperature and the residence time in the primary zone of the reactor, the particles may completely fuse upon coagulation to form individual spheres on the order of 50 nm to 200 nm or they can partially fuse to form hard fractal-like aggregates.

As noted, in some embodiments an important contribution to the growing step is due to collisions between similar particles and agglomeration of the colliding particles to form a larger particle. The agglomeration (coagulation) preferably is complete that the colliding particles fuse together to form a new larger primary particle, with the prior primary particles of the colliding particles no longer being present. Agglomeration (coagulation) to this extent will often involve significant sintering to fuse the colliding particles. An important aspect of the growing step within the flame reactor is to control conditions within the flame reactor to promote the desired collision and fusing of particles following nucleation. Control of the coagulation and sintering (coalescence) rates controls the final product particle size and morphology (e.g., spherical particles versus aggregates).

In other embodiments, the growing step may occur or be aided by adding additional material to the nanoparticles following nucleation. In this situation, the conditions of the flame reactor are controlled so that the additional material, and optionally energy, is added to the nanoparticles to increase the weight average particle size of the nanoparticles into the desired range. Growth through addition of additional material and surface reaction of the latter on the already formed particles are described in more detail below. In some embodiments, the growing step may involve both collision/agglomeration and material additions.

In one embodiment, during the growing step, the primary particles grow to a weight average particle size (d50 value) in a range selected from the group consisting of 1 nm, 5 nm, 10 nm, 20 nm, and 40 nm. In one embodiment, during the growing step, the product particles (product nanoparticles or agglomerates) grow to a weight average particle size (d50 value) in a range having a lower limit selected from the group consisting of 50 nm, 60 nm, 70 nm, 80 nm, 90 nm, 100 nm, 125 nm and 150 nm and an upper limit selected from the group consisting of 10 nm, 20 nm, 30 nm, 40 nm, 50 nm, 60 nm, 70 nm, 80 nm, 90 nm, 100 nm, 125 nm, 150 nm, 200 nm, 250 nm, 300 nm, 400 nm and 500 nm; provided that the upper limit is selected to be larger than the lower limit.

One particularly desirable aspect of the invention is the ability to form a population of nanoparticles, as formed, having a narrow distribution of particles. The narrow particle size distributions made possible by the present invention may be characterized by the standard deviation of the population of nanoparticles. In various aspects, the population of nanoparticles, as formed, has a standard deviation less than about 2.2, less than about 2.0, less than about 1.8, less than about 1.6, less than about 1.4, less than about 1.3 or less than about 1.2.

In one aspect, a majority of the nanoparticles formed by the processes of the present invention comprises a primary aggregation of primary nanoparticles. Especially when making larger nanoparticles it is important to provide sufficient residence time at sufficiently high temperature to permit the desired particle growth. These larger-size nanoparticles are desirable for many applications, because the larger-size nanoparticles are often easier to handle, easier to disperse for use and more readily accommodated in existing product manufacturing operations. By larger-size nanoparticles it is meant those having a weight average particle size of at least 50 nm, at least 70 nm and or at least 100 nm or even larger (e.g., about 1 micron). Growing nanoparticles to those larger sizes will, in some cases, require a controlled secondary zone in the flame reactor, because the particle size attainable in the primary zone may be smaller than the desired size. Also, it is important to emphasize that the size of the nanoparticles as used herein refer to the primary particle size of individual nanoparticulate domains, and should not be confused with the size of aggregate units of necked-together primary particles. Unless otherwise specifically noted, particle size herein refers only to the size of the identifiable primary particles.

In one aspect, the methods of the present invention involve making relatively large-size nanoparticles having a relatively low-melting temperature material. The low-melting temperature material preferably has a melting temperature that is less than about 2000° C. In some embodiments, the low-melting temperature material may have a melting temperature within a range having a lower limit selected from the group consisting of 200° C., 300° C., 400° C., 500° C., 600° C., 700° C., 800° C. and 900° C. and an upper limit selected form the group consisting of 2000° C., 1900° C., 1800° C., 1700° C., 1600° C., 1500° C., 1400° C., 1300° C., 1200° C., 1100° C. and 1000° C. The nanoparticles may be made entirely of the low-melting temperature material or the low-melting temperature material may be one of multiple phases when the nanoparticles are multi-phase nanoparticles. The low-melting temperature materials may be metal or ceramic and may be organic or inorganic, although inorganic materials are generally preferred. Some examples of metals that are low-melting temperature materials that may be processed with this implementation of the invention (and their melting temperatures) include: silver, gold, copper, nickel, chromium, zinc, antimony, barium, cesium, cobalt, gallium, germanium, iron, lanthanum, magnesium, manganese, palladium, platinum, uranium, strontium, thorium, titanium and yttrium and alloys (including intermetallic compounds) of any number of the foregoing. Other metal alloys (including intermetallic compounds) including a metal component with a higher melting temperature may nevertheless also have melting temperatures applicable for processing according to this implementation of the invention (e.g., including many eutectic compositions). Some examples of ceramics that are low-melting temperature materials and may be processed with this implementation of the invention include: some oxides, such as tin oxides, indium tin oxide, antimony tin oxide and molybdenum oxides; some sulfides, such as zinc sulfide; and some silicates, such as borosilicate glasses. Also, a number of metal alloys and intermetallic compositions including one or more of these metals have low melting temperatures and are processible with this implementation of the invention.

At least a portion of the growing step will optionally be performed in a volume of a flame reactor downstream from the primary zone that is better suited for controllably growing nanoparticles to within the desired weight average particle size range. This downstream portion of the flame reactor is referred to herein as a secondary zone to conveniently distinguish it from the primary zone discussed above.

FIG. 3, discussed above, shows an embodiment of flame reactor 106 having a secondary zone 134 for aiding growth of the nanoparticles to attain a weight average particle size within the desired range. As shown in FIG. 3, the secondary zone is a volume within conduit 108 that is downstream from the primary zone 116. The secondary zone 134 will optionally be longer and occupy more of the internal reactor volume than the primary zone 116, and the residence time in the secondary zone 134 may be significantly larger than in the primary zone 116.

Optionally, an insulating material, not shown, surrounds and insulates the portion of the conduit 108 that includes the secondary zone 134. Additionally or alternatively, the secondary zone, or a portion thereof, is surrounded by a heater, not shown. The heater is used to input heat into the flowing stream while the flowing stream is within the secondary zone. The additional heat added to the secondary zone 134 by the heater, provides control to maintain the nanoparticles at an elevated temperature in the secondary zone that is higher than would be the case if the heater were not used. The heater may be any device or combination of devices that provides heat to the flowing stream in the secondary zone. For example, the heater may include one or more flames or may be heated by a flame or a circulating heat transfer fluid. In one embodiment, the heater includes independently controllable heating zones along the length of the secondary zone 134, so that different subzones within the secondary zone 134 may be heated independently. This could be the case for example, when the secondary zone is a hot wall tubular furnace including multiple independently controllable heating zones.

The embodiment of flame reactor 106 shown in FIG. 3 is merely one example of a flame reactor for use with performing the method of the present invention. In other embodiments, the primary zone and the secondary zone may be within different conduit configurations or within different equipment or apparatus in fluid communication. Additionally, as further described below, the primary zone and the secondary zone may be separated by other processing zones such as a quench zone and/or a particle modifying zone, described in more detail below.

The following is a description of how the method of one aspect of the invention may be performed using the flame reactor 106 shown in FIG. 3. During the introducing step, feed 120 of a precursor medium comprising a nongaseous precursor is introduced into primary zone 116 through burner 112. Oxidant and a fuel are also fed to the flame through burner 112 for combustion to maintain the flame 114. The oxidant and/or fuel may be fed to the burner 112 together with or separate from the feed of the nongaseous precursor 120. In the primary zone, the physicochemical phenomena that take place are in the following order: droplet evaporation, combustion of liquid vehicle and/or precursor, precursor reaction/decomposition, particle formation via nucleation, and particle growth by coagulation and sintering. Particle growth continues into the secondary zone. The temperature attained in the primary zone 116 preferably is sufficiently high so that substantially all material of the target component in the nongaseous precursor is transferred through the gas phase, and nucleation at least begins in primary zone 116. As the flowing stream in the flame reactor 106 exits the primary zone 116 and enters secondary zone 134, the nanoparticles are growing. In secondary zone 134, conditions are maintained that promote continued growth of the nanoparticles to a large size within the desired weight average particle size range.

As noted previously, the residence time in the secondary zone may be longer than the residence time in the primary, or hot zone. By the term “residence time” it is meant the length of time that the flowing stream, remains within a particular zone (e.g., primary zone or secondary zone) based on the average stream velocity through the zone and the geometry of the zone.

In one embodiment the residence time within the primary zone is less than one second, and optionally significantly less. Often the flowing stream has a residence time in the primary zone (and also the flame) in a range having a lower limit selected from the group consisting of 1 ms, 10 ms, 100 ms, and 250 ms and an upper limit selected from the group consisting of 500 ms, 400 ms, 300 ms, 200 ms and 100 ms, provided that the upper limit is selected to be larger than the lower limit. In one embodiment the residence time within the secondary zone is at least twice as long, four times as long, six times or ten times as long as the residence time in the primary zone (and also as the residence time in the flame). Often, the residence time in the secondary zone is at least an order of magnitude longer than the residence time in the primary zone. The residence time of the flowing stream in the secondary zone is often in a range having a lower limit selected from the group consisting of 50 ms, 100 ms, 500 ms, 1 second and 2 seconds and an upper limit selected from the group consisting of 1 second, 2 seconds, 3 seconds, 5 seconds and 10 seconds, provided that the upper limit is selected to be larger than the lower limit. In the foregoing discussion, it should be understood that the residence times discussed above with respect to the flowing stream through the secondary zone would also be the residence time of the nanoparticles in the secondary zone, since the nanoparticles are within the flowing stream. In one embodiment, the total residence for both the primary zone and the secondary zone is in a range having a lower limit selected from the group consisting of 100 ms, 200 ms, 300 ms, 500 ms and 1 second and an upper limit selected from the group consisting of 1 second, 2 seconds, 3 seconds, 5 seconds and 10 seconds, provided that the upper limit is selected to be larger than the lower limit.

In determining an appropriate residence time of the nanoparticles in the secondary zone there are several considerations. Some of the considerations include the desired weight average particle size, the melting temperature (and sintering temperature) of materials in the nanoparticles, the temperature within the secondary zone, residence time in the secondary zone and the number concentration of the nanoparticulates in the flowing stream (i.e., number of nanoparticles per unit volume of the flowing stream).

With respect to the number concentration of nanoparticles flowing through the secondary zone, if such number concentration is sufficiently large, then the nanoparticles will tend to collide more frequently providing greater opportunity for particle growth more quickly, requiring less residence time within the secondary zone to achieve a desired weight average particle size. Conversely, if the nanoparticulate concentration within the secondary zone is small, the collisions between nanoparticles will be less frequent and particle growth will necessarily proceed more slowly. Moreover, there is a particular number concentration of nanoparticles, referred to herein as a “characteristic number concentration,” below which particle collisions become so infrequent that for practical purposes the nanoparticles effectively stop growing due to particle collisions. Another way of describing the characteristic number concentration of nanoparticles is that it is the minimum number concentration of nanoparticles in the secondary zone that is necessary from a practical perspective to achieve a particular weight average particle size for the nanoparticles through collisions in a residence time that is reasonably practical for implementation in a flame reactor system. The characteristic number concentration will be different for different weight average particle sizes.

If the temperature within the secondary zone is set to promote the growth of the nanoparticles through collisions of the nanoparticles (i.e. high enough for colliding particles to fuse to form a single nanoparticulate), then control of the number concentration of the nanoparticles and residence time in the secondary zone are two important control variables. Thus, if the number concentration of nanoparticles in the secondary zone is maintained at a specific concentration, then the residence time within the secondary zone will be changed in order to achieve the desired extent of collisions to achieve a weight average particle size in a desired range. However, if the residence time is set, then the number concentration of nanoparticles within the secondary zone may be controlled so that the desired weight average particle size is achieved within the set residence time. Control of the weight average particle size may be achieved for example by changing the temperature in the secondary zone and changing the concentration of the precursor in feed to the primary zone, or a combination of the two, or by changing the reactor cross-sectional area and/or the cross-sectional area of the flame at its broadest point. In one embodiment, the ratio of the cross-sectional area of the flame at its broadest point and the cross-sectional area of the reactor at that same point is preferably 0.01 to 0.25. Conversely, for a set residence time and temperature profile in the secondary zone, the concentration of nongaseous precursors (and other precursors) fed to the primary zone may be adjusted to achieve a desired volume concentration in the secondary zone to achieve at least the characteristic volume concentration for a desired weight average particle size.

Temperature control in the secondary zone of the flame reactor is very important. Maintaining the temperature of the secondary zone within a specific elevated temperature range may include retaining heat already present in the flowing stream (e.g., residual heat from the flame in the primary zone). This may be accomplished, for example, by insulating all or a portion of the conduit through the secondary zone to reduce heat losses and retain a higher temperature through the secondary zone. In addition to or instead of insulating the secondary zone, heat may be added to the secondary zone to maintain the desired temperature profile in the secondary zone.

The temperature in the secondary zone is maintained below a temperature at which materials of the nanoparticles would vaporize or thermally decompose, but above a sintering temperature of the nanoparticles. By “sintering temperature” it is meant a minimum temperature, at which colliding nanoparticles sticking together will fuse to form a new primary particle within the residence time of the secondary zone. The sintering temperature of the nanoparticles will, therefore, depend upon the material(s) in the nanoparticles and the residence time of the nanoparticles in the secondary zone as well as the size of the nanoparticles. In those embodiments where the growing of the nanoparticles includes significant growth through particle collisions, the nanoparticles should be maintained at, and preferably above, the sintering temperature in the secondary zone.

When the nanoparticles are multi-phase particles, the “sintering temperature” of the nanoparticles will vary depending upon the materials involved and their relative concentrations. In some cases, the sintering together will be dictated by the lowest melting temperature material so long as that material is sufficiently exposed at the surface of colliding particles to permit the low-melting temperature domains to fuse to an extent to result in a new primary particle through the action of the lower-melting temperature material.

In a variation of the present invention, the nanoparticles are maintained through at least a portion of, and perhaps the entire secondary zone, at or above a melting temperature of at least one material in the nanoparticles, promoting rapid fusing and formation of a new primary particle. In another variation, the nanoparticles are maintained, through at least a portion of and perhaps the entire secondary zone, at a temperature that is within some range above or below the melting temperature of at least one material of the nanoparticles. For example, the temperature of the flowing stream through at least a portion of the secondary zone may be within a temperature range having a lower limit selected from the group consisting of 300° C. above the melting temperature of the material, 200° C. above the melting temperature of the material and 100° C. above the melting temperature and having a lower limit selected from the group consisting of 300° C. below the melting temperature of the material, 200° C. below the melting temperature of the material and 100° C. below the melting temperature of the material, provided that the upper limit must be selected to be below a vaporization temperature of the material and below a decomposition temperature of the material where the material decomposes prior to vaporizing. In a further variation, the temperature of the flowing stream in the secondary zone does not exceed a temperature within the selected range. As used herein, the temperature in the secondary zone and the stream temperature in the secondary zone are used interchangeably and refer to the temperature in the stream in the central portion of a cross-section of the conduit. As will be appreciated, the flowing stream will have a temperature profile across a cross-section of the flow at any point, with the temperature at the edges being higher or lower than in the center of the stream depending upon whether there is heat transfer into or out of the conduit through the wall.

In some embodiments, the growing step includes adding additional material to the nanoparticles (other than by collision/agglomeration) to increase the weight average particle size into a desired size range. The additional material may be the same or different than the material resulting from the nongaseous precursor discussed above.

When the additional material includes the same component as the component provided by the nongaseous precursor, discussed above, the additional amount of the component added to the nanoparticles may be derived from addition of more of the nongaseous precursor or from a different precursor or precursors. Moreover, the additional material added to the nanoparticles may result from additional precursor or precursors introduced into the flame reactor separate in the primary zone and/or the secondary zone.

An additional precursor may be included into the flame reactor during the introducing step as part of a combined feed with the nongaseous precursor, discussed above, when the additional precursor is different than such nongaseous precursor. Alternatively, additional precursors may be introduced separately into the flame reactor into the primary and/or secondary zone.

The following includes a description of various embodiments of the present invention in which one or more than one additional precursor is added to the flame reactor.

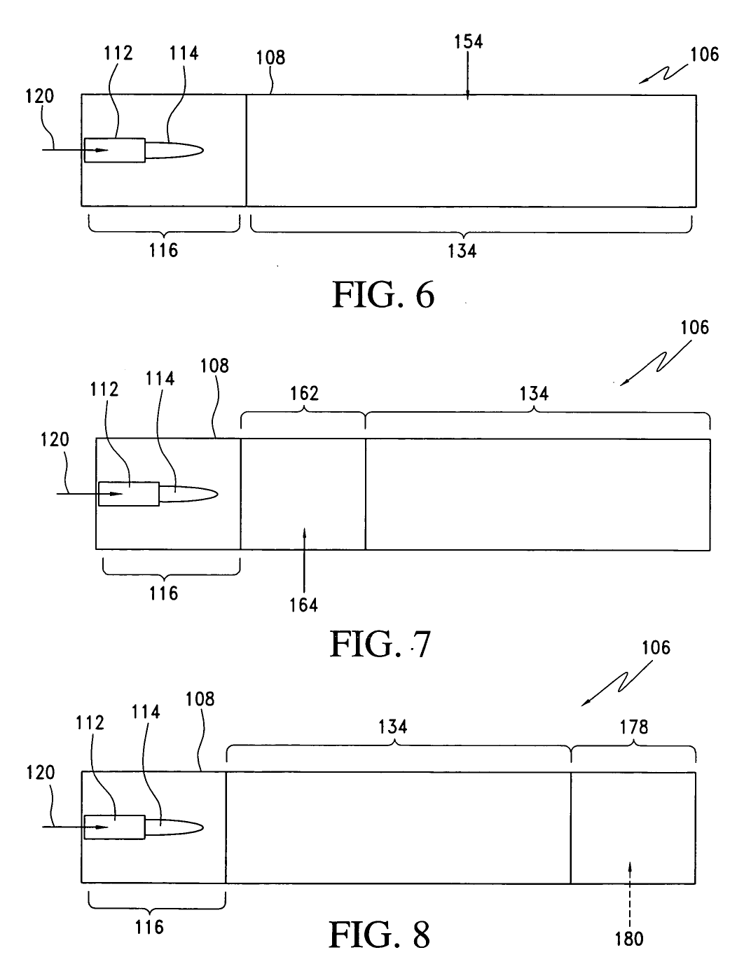

FIG. 6 shows an embodiment of flame reactor 106 that includes a feed 154 introduced into the secondary zone 134. Feed 154 includes a precursor or precursors for material for growth of the nanoparticles in the secondary zone during the step of growing the nanoparticles. The feed 154 may include liquids, solids, gases and combinations thereof. Each precursor in feed 154 may be in the form of a liquid (including a solute in a liquid) a solid, or a gas. For example, a precursor in feed 154 may be a liquid phase precursor (e.g., a liquid substance or dissolved in a liquid). The liquid precursor may be introduced into secondary zone 134 in disperse droplets. As another example, a precursor may be a solid precursor which may be introduced into the secondary zone 134 in the feed 154 as dry disperse particulates or particulates contained in droplets. In another example, a precursor may be gaseous and included in a gas phase of feed 154.

The feed 154 and precursor(s) contained therein may be introduced into secondary zone 134 in a variety of ways. For example, if the precursor is contained in a liquid or a solid, it may be introduced into the secondary zone 134 in a disperse phase (e.g., droplets or particles) dispersed in a gas phase of feed 154. In other cases, feed 154 may only include the precursor in a liquid or a solid form with no additional phases or materials (i.e., feed 154 may be liquid sprayed into the secondary zone or a solid particulate feed into the secondary zone 134 without the aid of a gas phase).

In one variation, feed 154 may be introduced into the secondary zone 134 through a burner and a flame generated by that burner. The heat from the flame may be used to vaporize or otherwise react a precursor in feed 154 as may be necessary for forming the material to promote growth of the nanoparticles in the secondary zone 134.

The introduction of feed 154 into secondary zone 134 may occur at various locations within the secondary zone 134, rather than at only one location as shown in FIG. 6. The invention is not limited to introduction of a single feed as shown in FIG. 6. Different ones of a plurality (i.e., more than one) of feeds may be introduced at different locations along the secondary zone 134, and the different feeds need not be of the same composition or include the same precursor(s). For example, a feed may be introduced at the beginning of secondary zone 134 and another feed of additional material may be introduced near the middle of secondary zone 134. In another example, several feeds may be at spaced locations along the secondary zone 134. The invention is not limited to these variations, and other variations are possible.

Different feeds that may be introduced into the secondary zone 134 do not have to include precursor(s) to the same materials or materials for inclusion in the nanoparticles. Precursor(s) to different materials in differed spaced feeds may be desirable, for example, to form sequences of layers of different materials on the nanoparticles.

In one implementation of the embodiment of the present invention utilizing the flame reactor 106 shown in FIG. 6, feed 154 has a precursor to an additional material that is different than any material already contained in the nanoparticles when the nanoparticles exit the primary zone 116. This implementation may be useful for making nanoparticles including two or more different materials that are preferably formed under different processing conditions. This embodiment is also useful for making multi-phase nanoparticles when a particular morphology is desired. For example, the additional material added to the nanoparticles in the secondary zone may form a coating on the nanoparticulates to form nanoparticles with a core/shell morphology or it may decorate the surface of the support particles with nanoparticles. The additional material may also react to form particles that are segregated from the particles produced in the primary zone, thus resulting in a mixture of two or more different types of particles in the product particles.

In one particularly preferred embodiment, the present invention is directed to a flame spray process for forming product particles, preferably composite particles, and more preferably composite nanoparticles. By “composite particles” it is meant particles formed of a plurality of materials, e.g., particles having a homogenous mixture of two or more materials or particles having a core/shell structure. By “core/shell structure,” it is meant that the composite particles comprise: (1) a core comprising a first material; and (2) a shell partially or totally surrounding the core and comprising a second material. For example: core/shell may mean core particle that is decorated by finer nanoparticles of a second component. It may also mean a composite particle that has distinct regions with different components incorporated within each region.

In one aspect, the present invention is directed to a flame spray process for forming product particles, e.g., composite particles, having a core/shell structure. The process comprises the steps of: (a) providing a first precursor medium comprising a first liquid vehicle, support particles distributed in the first liquid vehicle, and a nongaseous precursor to a component; and (b) flame spraying the first precursor medium under conditions effective to form product particles, e.g., composite particles, comprising the component dispersed on the support particles.

In one aspect, the process further comprises the steps of: (c) providing a second precursor medium comprising a second liquid vehicle and a precursor to the support particles; and (d) flame spraying the second precursor medium under conditions effective to form the support particles, wherein steps (c) and (d) optionally occur before steps (a) and (b).

The composite particle formed by the process may comprise a nanoparticles of the component dispersed on the support particles. The dispersion, defined as the ratio of measured and theoretically possible surface area of the component, may vary from 10% to almost 100%. The dispersion of the component on the support particles can be controlled, for example, by the concentration ratio of the nongaseous precursor to the support particle concentration, the choice of the nongaseous precursor, and reactor temperature distribution. The loading of the component relative to the support particle material may vary from 0.001% to 70%. The composite particles formed by the processes may also comprise a coating of the component on the support particles. Coating thickness may vary from 1 nm to 10 nm. The thickness of the coating is controlled, for example, by the concentration ratio of the nongaseous precursor to the support particle concentration, the flame temperature, and the level of mixing within the first liquid vehicle.

Depending on the conditions in the flame spray reactor, the composite particles may comprise a population of nanoparticles comprising the component on the support particles rather than a coating. The nanoparticles may have any of the characteristics, e.g., particle size, described above. The population of nanoparticles optionally has a d95 less than about 200 nm.

The support particles optionally have an average particle size of less than about 10 μm, e.g., less than about 5 μm or less than about 1 μm. The support particles optionally comprise a material selected from the group consisting of: a metal, a metal oxide, a metal salt, a nitride, a carbide, a sulfide and carbon.

In this aspect of the invention, at least 90 weight percent, at least about 95 weight percent or at least about 97 weight percent of the nongaseous precursor to the component in the first precursor medium is converted to the component.

In one variation, the different material formed and deposited on the nanoparticles in the second zone aids growth of the nanoparticles through enhancement of the sinterability of colliding nanoparticles. The different material added to the nanoparticles may have, for example, a lower sintering and/or melting temperature than other material(s) in the nanoparticles, and addition of this additional material on the exposed surface of the nanoparticles will assist colliding particles to stick together and fuse to form a new primary particle. This is particularly the case if the temperature in secondary zone 134 is maintained at a temperature above the melting temperature of the additional material. The presence of liquid phase material or other flux-like material exposed at the surface of the nanoparticles will significantly aid the prospect that colliding particles will join together and form a new primary particle. This embodiment is particularly useful for growing nanoparticles containing high-melting temperature material(s) that might not otherwise stick together and sufficiently sinter to form a new, larger primary aggregate.

When the growing step includes growing the nanoparticles through collisions, in one implementation the growth may be aided by the use of a fluxing material. By the term “fluxing material” or simply “flux”, which are used interchangeably herein, it is meant a material that promotes and aids in fusing, sintering or coalescing of two colliding nanoparticles to form a new primary particle larger in size than either of the two colliding nanoparticles. The previously described embodiment of adding an additional material to the nanoparticles in secondary zone 154 that is of a lower melting temperature than other materials in the nanoparticles is one example of the use of a fluxing material. However, the use of a fluxing material is not limited to that embodiment. For example, a fluxing material does not have to be a liquid or be in a liquid phase during the growing step in order to aid in growing the nanoparticles. In some cases, the fluxing material may be a solid phase.

The fluxing material may be introduced into the flame reactor at any convenient location as long as the introduction and subsequent processing results in exposure of the fluxing material at the surface of the nanoparticles through at least some portion of the secondary zone during the growing step. With reference to FIG. 3, as one example, the fluxing material may be introduced as part of the flowing stream during the step of introducing the precursor medium into primary zone 116. As another example, the fluxing material may be added into secondary zone 134, such as, for example, part of feed 154 into the secondary zone during the growing step. One advantage of introducing the fluxing material in feed 154 is the ability to controllably deposit the fluxing material on the outside of the nanoparticles. The fluxing material should be introduced in such a manner and/or be of such a type that the fluxing material deposits on the surface of already formed nanoparticles or through phase interaction in the nanoparticles migrates to the surface of the nanoparticles, so that it will be available at the surface of the nanoparticles to aid growth of colliding particles. The fluxing material does not, however, have to completely cover an outside surface of the nanoparticles, but only needs to be exposed at over a sufficient portion of the surface to provide the growth aiding effect to colliding particles.

High-melting temperature materials, which may be processed with use of a fluxing material include high-melting temperature metals and ceramics. The high melting temperature material may have a melting temperature of at least as high as or higher than a temperature selected from the group consisting of 1800° C., 1900° C., 2000° C., and 2200° C., but generally lower than 3000° C. or even lower than 2500° C. Some examples of metals that may be considered high-melting temperature materials include boron, chromium, hafnium, iridium, molybdenum, niobium, osmium, rhenium, ruthenium, tantalum, tungsten and zirconium. Some classes of ceramics that include materials that may be considered as being high-melting temperature materials include oxides, nitrides, carbides, tellurides, selenides, titanates, tantalates and glasses.

The product particles ultimately formed according to the present invention optionally comprise primary particles. By “primary particles,” it is meant identifiable particulate domains that are either substantially unagglomerated (i.e., substantially unattached to each other) or if agglomerated never the less retain the identifiable particulate attributes, in that the particulate domains are joined together through necking between the still identifiable separate particulate domains. In some embodiments of the invention, the product particles are substantially unagglomerated, while in other embodiments the nanoparticles may be in the form of aggregates which may be hard agglomerates (meaning that the agglomerates are not easy to break apart to release the individual nanoparticles). As will be appreciated, when the nanoparticles are in the form of aggregates, the aggregate units will be of a larger size than the nanoparticles. Such aggregate units may include only two nanoparticles or may comprise dozens or even hundreds or more of the nanoparticles. In most, but not all embodiments, it is preferred that the nanoparticles made according to a method of the invention are either substantially unagglomerated or in the form of soft agglomerates that are easily broken up.

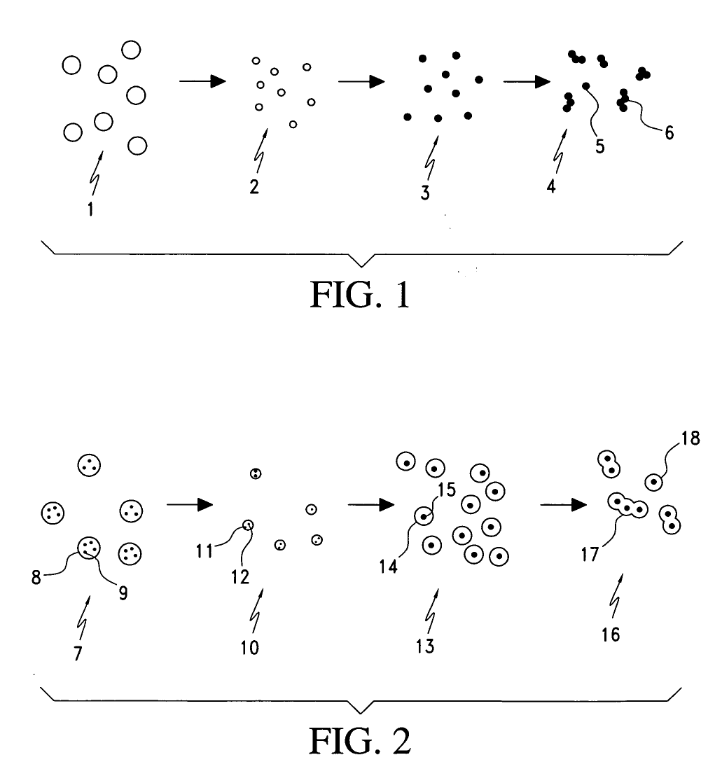

FIG. 1 illustrates one non-limiting example of how nanoparticles and aggregates of nanoparticles of a single phase may be formed during a flame spray process. As shown, droplets 1 comprising a nongaseous precursor to a component and optionally a liquid vehicle are formed in an atomization step. As the droplets 1 contact the flame in the flame reactor, the liquid vehicle vaporizes to form smaller droplets 2. The vaporized liquid vehicle and the precursor combust in the presence of oxygen. The combustion reaction generates enough heat to completely evaporate the droplets and vaporize the non-gaseous precursor. The vaporized nongaseous precursor reacts in the gas phase to form nanoparticles 3, which comprise the component. Alternatively, the vaporized nongaseous precursor reacts in the smaller droplets 2. As the nanoparticles 3 flow through the flame reactor they may agglomerate to form nanoparticles 4, where nanoparticles have grown to form product agglomerate particles 5 and/or that have agglomerated to form aggregate particles 6. Advantageously, the degree of aggregation can be controlled by carefully controlling the temperature of the nanoparticles 6 after they are formed. Generally, the further downstream the cooling step occurs, the larger the ultimately formed product particles will be. Conversely, cooling the nanoparticles 6 immediately after they are formed, e.g., with a quench medium, will reduce aggregate particle formation. If aggregates are desired, then the cooling should occur downstream in the reactor to allow the nanoparticles to agglomerate.

In a preferred aspect of the invention, the product particles comprise multi-phase particles. The different phases of the multi-phase particles may be distributed within the product particles in any of a variety of morphologies. For example, two or more of the phases may be intimately mixed together, or one or more phases may form a core phase surrounded by a shell of one or more other phases that form a shell (or covering) about the core, or one or more phases may be in the form of a dispersion dispersed in a matrix comprised of one or more other phases. Such multi-phase nanoparticles include at least two phases, but may include three, four or even more than four phases.

FIG. 2 illustrates a non-limiting example of how to form multi-phase particles and agglomerates of multi-phase particles with a flame spray process. Specifically, FIG. 2 illustrates a flame spray process for forming product particles having a core/shell structure as well as the formation of agglomerates of nanoparticles having a core/shell structure during a flame spray process of the present invention. As shown, droplets 7 comprise particles 9, and a liquid phase 8, which comprises a nongaseous precursor to a component and, optionally, a liquid vehicle. As the droplets 7 contact the flame in the flame reactor, the liquid phase vaporizes to form smaller droplets 10. Smaller droplets 10 comprise the particles 12 and the liquid phase 11, although the liquid phase 11 will be present in a smaller amount than liquid phase 8 in droplets 7. Liquid phase 11 may comprise the same components as were present in liquid phase 8 of droplets 7, just in a smaller amount due to the vaporization thereof. As the heating continues in the flame reactor, core/shell product particles 13 are formed. Specifically, as the heating continues, the nongaseous precursor in the smaller droplets 10 reacts to form shells 14 on core particles 15. Alternatively, the droplets evaporate completely leaving behind only the support particles. The non-gaseous precursor vaporizes from the heat of combustion and reacts by surface reaction on the core particles to form coatings. As the core/shell product particles 13 flow through the flame reactor they may agglomerate to form agglomerate core/shell particles 16. Advantageously, the degree of aggregation can be controlled by carefully controlling the temperature of the core/shell product particles 13 after they are formed. Generally, the further downstream the cooling step occurs, the larger the ultimately formed agglomerate core/shell product particles 16 will be. Conversely, cooling the nanoparticles 6 immediately after they are formed, e.g., with a quench medium, will reduce aggregate particle formation. If aggregates are desired, then the cooling should occur downstream in the reactor to allow the nanoparticles to aggregate.

In one preferred embodiment, the product particles, e.g., product nanoparticles, made with the method of the present invention are spheroidal. By the term “spheroidal” it is meant a shape that is either spherical or resembles a sphere even if not perfectly spherical. For example such spheroidal product particles, although of rounded form, may be elongated or oblong in shape relative to a true sphere. As another example, such spheroidal product particles may have faceted or irregular surfaces other than the rounded surfaces of a sphere. Also, the product particles may have significant internal porosity or may be very dense, with particles of higher density generally being preferred. In one implementation, the product particles have a density of at least 80 percent, or at least 85 percent or even at least 90 percent of theoretical density for the composition of the product particles, as measured by helium pyconometry or other density measurements. In some applications, however, it may be desirable to have very high specific surface area, and the product particles may include a significant amount of porosity.

The product particles formed by the process of the present invention may be suitable for a variety of applications. Depending upon the final application, the product particles may be made with a wide variety of compositions and other properties. For example, the product particles may be transparent (such as for use in display applications), electrically conductive (such as for use in electronic conductor applications), electrically insulative (such as for use in resistor applications), thermally conductive (such as for use in heat transfer applications), thermally insulative (such as for use in a heat barrier application) or catalytically active (such as for use in catalysts applications). In one example, the process of the present invention may be used to produce heterogeneous catalysts comprising an active catalytic component/phase dispersed on a high surface area support/carrier, optionally together with a promoter component. Non-limiting examples of promoter components include metal oxides or alkaline earth metals (e.g., CeO₂, elemental sodium and elemental potassium). In one capacity, the promoter component serves to increase the activity or stability of the active catalytic component/phase. In another capacity, the promoter component may serve to improve dispersion of the active catalytic component/phase. Some examples of catalytically active components/phases include noble metals (e.g., Pt, Pd, Rh, etc.), base metals (e.g., Ni, Co, Mo, etc.), metal oxides (e.g., CuO, MoO₂, Cr₂O₃, Fe₂O₃, etc.) or metal sulfides (e.g., MoS₂, Ni₃S₂, etc.). Some examples of support/carriers include carbon, aluminum oxide, silicon dioxide, zirconium oxide, cerium oxide, titanium oxide, etc. Other nonlimiting examples of possible properties of the product particles for use in other applications include: semiconductive, luminescent, magnetic, electrochromic, capacitive, bio-reactive and bio-ceramic.

Table 1 lists some nonlimiting examples of materials that may be included in the product particles made with various implementations of the method of the present invention. Table 1 also lists some exemplary applications for product particles that may include the listed materials. Other nonlimiting examples of materials that may be included in the product particles made with various implementations of the method of the present inventions are each and every one of the materials disclosed for inclusion in nanoparticles in U.S. patent application Ser. Nos. 11/117,701, filed Apr. 29, 2005; 11/199,512, filed Aug. 8, 2005; and 11/199,100, filed Aug. 8, 2005, the entireties of which are incorporated herein by reference.

TABLE 1

| Product Particle | | |
|---|---|---|
| Material | Example Formula | Exemplary Applications |
| Simple Oxides | | |
| Alumina | Al₂O₃ | Chemical Mechanical |
| | | Planarization (CMP), |
| | | Catalysis |
| Magnesia | MgO | CMP |
| Ceria | CeO₂ | Catalysis, Optics, CMP |
| Zirconia | ZrO₂ | CMP, Catalysis |
| Titania | TiO₂ | Pigments, Catalysis |
| Titanium suboxide | TiO | Pigments |
| Silica | SiO₂ | Ceramics |
| Iron oxides | Fe₂O₃, Fe₃O₄ | Electronics, recording |
| | | media |
| Zinc Oxide | ZnO | Electronics, recording |
| | | media |
| Tin oxide | SnO | Electronics, recording |
| | | media |
| Bismuth oxide | Bi₂O₃ | Electronics, recording |
| | | media |
| Yttria | Y₂O₃ | Optics |
| Calcium oxide | CaO | Catalysis |
| Strontium oxide | SrO | Ceramic, Catalysis |
| Nickel oxide | NiO | Catalysis, Electronics |
| Ruthenium oxide | RuO | Electronics |
| Indium tin oxide | | Electronics |
| (ITO) | | |
| Aluminates | | |
| Calcium aluminate | CaAl₂O₄ | Ceramics |
| Magnesium | MgAl₂O₄ | Ceramics |
| aluminate | | |
| Barium aluminate | BaAl₂O₄ | Ceramics |
| Strontium | SrAl₂O₄ | Ceramics |
| aluminate | | |
| SILICATES | | |
| Zinc silicate | Zn₂SiO₄ | Optics |
| Yttrium silicate | Y₂SiO₅ | Optics |
| TITANATES | | |
| BARIUM TITANATE | BaTiO₃ | Electronic |
| Strontium | SrTiO₃ | Electronic |
| titanate | | |
| Aluminum titanate | AlTiO | Ceramics |
| Barium-strontium | (Ba₍₁₋ₓ₎Srₓ₎TiO₃ | Electronics |
| titanate | | |
| Mixed or Complex | | |
| Oxides | | |
| Ceria-zirconia | CeO₂:ZrO₂ | Catalysis (automotive) |
| YSZ | ZrO₂:Y₂O₃ | Ceramics, Sensors |
| Alumina-silica | 3Al₂O₃:2SiO₂ | Ceramics |
| (Mullite) | | |
| Strontia-alumina- | SrO—Al₂O₃—SiO₂ | Ceramics |
| silica | | |
| Zinc-silica | ZnO—SiO₂ | Electronic |
| Indium tin oxide | | Electronic, transparent |
| (ITO) | | conductor |
| Metals | | |
| Cobalt | Co | Optics |
| Copper | Cu | Electronics, Optics |
| Silver | Ag | Electronics, Optics |
| Gold | Au | Electronic |
| Platinum | Pt | Catalysis |
| Iridium | Ir | Catalysis |
| METALS ON METAL | | |
| OXIDES | | |
| Platinum on | Pt:Al₂O₃ | Catalysis |
| alumina | | |
| Platinum on tin | Pt:SnO₂ | Electronic |
| oxide | | |
| Platinum on | Pt:TiO₂ | Catalysis |
| titania | | |
| Silver on alumina | Ag:Al₂O₃ | Catalysis |
| Gold on titania | Au:TiO₂ | Electronic |
| Gold on Silica | Au:SiO₂ | Electronic |
| Molybdenum and/or | Mo/Co:Al₂O₃ | Catalysis |
| cobalt on alumina | | |
| COMPLEX | | |
| COMPOSITIONS | | |
| Ferrites | | Electronic |
| Chromates | | Electronic |
| Superconductors | YBaCuO | Electronic |
| METAL DOPED | | |
| MATERIALS | | |
| Europia doped | Y₂O₃:Eu | Optics |
| yttria | | |
| Terbia doped | Y₂SiO₅:Tb | Optics |
| yttrium | | |
| silicate | | |
| | SrTiO₃:Pr | Optics |
| | Zn₂SiO₄:Mn | Optics |
| | (Y_{(1-x-y)}YbₓRe_{y})₂O₃ | Optics |

The product particles that are made using the methods of the present invention may advantageously be made with a specific combination of sizes and properties for use in a desired application. For example, for applications such as pigments, metals for electronics, ceramic green bodies, some solid oxide fuel cells and phosphors, the nanoparticles may preferably be made spheroidal, dense with a larger weight average particle size. For applications such as transparent coatings, some solid oxide fuel cells, inks (for methods of preparing and using inks comprising nanoparticles see, e.g., U.S. Provisional Application Ser. Nos. 60/643,577; 60/643,629; and 60/643,378, all filed on Jan. 14, 2005, the entireties of which are incorporated herein by reference; co-pending non-provisional patent applications bearing Cabot docket numbers 2005A001.2, 2005A002.2, and 2005A003.2, the entireties of which are incorporated herein by reference; and U.S. patent application Ser. Nos. 11/117,701, filed Apr. 29, 2005; 11/199,512, filed Aug. 8, 2005; and 11/199,100, filed Aug. 8, 2005, the entireties of which are incorporated herein by reference), chemical-mechanical polishing, catalysis and taggants/security printing, the nanoparticles may preferably be made to be spheroidal, dense and with a smaller weight average particle size. For applications such as catalysts, the nanoparticles may preferably be made porous with a highly dispersed catalytically active phase decorating the support particles. As another example, the nanoparticles may be made as agglomerates (hard or soft), with the nanoparticles preferably having a larger or a smaller weight average particle size, depending upon the application. For applications such as transparent conductors, rheology additives (e.g., thickeners, flow indicators), chemical-mechanical planarization (CMP), security printing taggants, catalysis, optical applications, cosmetics, and applications involving electrical conductivity the nanoparticles may in some embodiments be made in the form of agglomerates of the nanoparticles. For applications such as structural ceramics, spherical or spheroidal nanoparticles can pack closer together, thus allowing higher solids loading in dispersions and higher density upon sintering. Such nanoparticles also have different Theological properties than aggregates when mixed with materials such as polyester resins, silicones. Aggregates tend to form networks when dispersed in these materials that cause thickening.

The foregoing are just some nonlimiting examples of materials, properties and applications of use for which the product particles may be designed. It should be understood that the product particles formed with the method of the present invention may have a variety of applications in other areas as well, and consequently be made with materials and/or properties, different from or in a different combination than those noted above.

In several aspects of the invention, the nanoparticles are modified in the flame reactor as they are formed or in a separate step after they are formed. The step of modifying the nanoparticles may be useful, for example, to change the properties of the nanoparticles after they have been formed and/or have been grown into a desired weight average particle size. By the term “modify” or “modifying,” it is meant a change to the nanoparticles that does not necessary involve increasing the weight average particle size of the nanoparticles. The modification may be morphological or chemical. By morphological it is meant changes to the structure of the nanoparticles, with some nonlimiting examples including a redistribution of phases within the nanoparticles, creation of new phases within the nanoparticles, crystallization or recrystallization of the nanoparticles, change in porosity and size of pores within the particle, and homogenization of the nanoparticles. A chemical modification to the nanoparticles includes compositional changes to the nanoparticles such as adding an additional component or removing a component from the nanoparticles to change the chemical composition of the nanoparticles, preferably without substantially increasing their weight average particle size, or changing the oxidation state of the component. For example, the nanoparticles may be doped with a doping material to change the luminescent, conductive, electronic, optical, magnetic or other materials properties of the nanoparticles. In another example, a surface modifying material may be added to the surface of the nanoparticles in order to aid the dispersion of the nanoparticles in a suitable medium for use in a final application. In one embodiment, the modification consists of a “polishing” step where additional heat is introduced in the form of flame (e.g., a flame curtain) in order to oxidize any carbon contamination that may exist in the product particles as a result of incomplete combustion in the primary zone. This polishing step is not meant to alter the physical characteristics of the particles (e.g., primary particle size and/or shape), but its purpose is to rid the particles of any undesirable species they may contain. This avoids the need for further post-processing of the particles in a separate processing step after they are made in the flame reactor.

In some applications, it may be desirable to remove the nanoparticles that are formed on support particles. Nanoparticles may be removed from support particles by chemical means (e.g, high shear dispersion, treatment with acid, or leaching). This creates porosity that can be advantageous in applications such as gas adsorption and catalysis. Alternatively, the support particle can be preferentially removed or dissolved to release the individual nanoparticles.

In a preferred aspect, the present invention is directed to a flame spray process in which particles of a first phase are converted to particles of second phase. As used in this aspect of the invention, the term “phase” means particles of a first phase that are thermodynamically stable or metastable where the atoms in the particles of the first phase are arranged in a certain order within a lattice. The order can appear at various length scales (nanometer, micrometer or larger) depending on the conditions that are used to produce and grow the particles of the first phase. In this embodiment, the process comprises the steps of: (a) providing a first precursor medium comprising a first liquid vehicle and particles of a first phase distributed in the first liquid vehicle; and (b) flame spraying the first precursor medium under conditions effective to convert the particles of the first phase to particles of a second phase. In a preferred embodiment, the particles of the first phase are amorphous, and the particles of the second phase are crystalline. In one aspect, the process further comprises the steps of: (c) providing a second precursor medium comprising a second liquid vehicle and a precursor to the particles of the first phase; (d) flame spraying the second precursor medium under conditions effective to form the particles of the first phase, wherein steps (c) and (d) optionally occur before steps (a) and (b). Since the particles of the first phase may be formed by various aspects of the present invention, the particle characteristics of the particles of first phase may be as described in detail above. Similarly, since the particles of the second phase are formed by the processes of the present invention, they too may have any of the various particle characteristics that are described in detail above. Depending on the process parameters and particles being converted, at least 90 weight percent, at least about 95 weight percent or at least about 97 weight percent of the particles of the first phase in the first precursor medium optionally are converted to the particles of the second phase.

In one preferred embodiment, the particles of the first phase comprise γ-alumina, and the particles of the second phase comprise α-alumina. The conversion from γ-alumina to α-alumina can be achieved when γ-alumina is processed at temperatures above 1300° C. in the flame reactor. In another embodiment, the particles of the first phase comprise bhoemite alumina and the particles of the second phase comprise γ-alumina, transition alumina (theta and delta combination) or α-alumina.

In another embodiment, the particles of the first phase comprise anatase titania and the particles of the second phase comprise rutile titania. The conversion from anatase titania to rutile titania may be achieved at high reactor temperatures (e.g., 1500° C.).

In another embodiment, the particles of the first phase comprise separate phases of metal oxides, and the particles of the second phase comprise one or several types of crystal composition distinct from the previous phases that comprises all of the first phase materials in a new lattice structure (e.g., perovskite, and other solid solutions). In yet another embodiment all of the components have diffused together but comprise a noncrystalline, amorphous structure. This can be accomplished by processing separate metal oxide phases at reactor temperatures that promotes diffusion of one phase into another phase. It also requires sufficient residence time at the primary zone to reach the thermodynamically stable mixed phase at the required temperature for the particular material in question.

The particles of the first phase optionally comprise a material selected from the group consisting of Ce, Zr, La, Fe, Zn, Al, Cu, CeO₂, ZrO₂, Al₂O₃, TiO₂, Fe₂O₃, Fe₃O₄, FeO, ZnO, and SiO₂.

FIG. 8 shows an embodiment of the flame reactor 106 that may be used to implement according to this aspect of the present invention. The flame reactor 106, includes the primary zone 116, the secondary zone 134 and a modifying zone 178. The modifying zone 178 is used to modify the nanoparticles. In some embodiments, unless subjected to a prior quench, the flowing stream in the modifying zone 178 will still be at an elevated temperature because of the residual heat from upstream operations. However, the temperature will often preferably be significantly below those temperatures described above with respect to the secondary zone 134 during the growing step, and a quench may be useful between the secondary zone 134 and the modifying zone 178 to adjust the temperature as desired. For example, the temperature of the nanoparticles when modified will be significantly lower than a melting temperature of any of the materials in the nanoparticles and preferably below the sintering temperature of the nanoparticles, to avoid growth of the nanoparticles through collisions and sintering. In any case, the nanoparticles should be maintained at a temperature at which the desired modification of the nanoparticles occurs.

The descriptions of the various designs of the secondary zone 134 described above are applicable to the modifying zone 178. For example, the modifying zone 178 may include an insulator around the portion of conduit 108 that forms the modifying zone 178. The insulator may be useful to retain heat in the flowing stream while the flowing stream is in modifying zone 178. Additionally, it may be necessary to add heat to modify the nanoparticles, in which case heat will be added to modifying zone 178.

FIG. 8 also shows optional feed 180 of modifying material that may be introduced into the modifying zone 178 for chemical, or compositional modification. The feed 180 of modifying material may be introduced into the modifying zone 178 in a variety of ways, including, all of the ways previously described with respect to the feed 154 of FIG. 6. For example, the modifying feed 180 may be introduced through a burner and into a flame in modifying zone 178.

Feed 180 of modifying material may include multiple phases such as a gas phase and a nongaseous phase. The nongaseous phase may include a liquid, a solid or a combination of a liquid and a solid. The modifying feed 180 includes a modifying material, or a precursor to a modifying material, which modifies the nanoparticles while in the modifying zone 178. The term “modifying material” is meant to include any material that is involved in “modifying” the nanoparticles as the term has been previously defined. The modifying feed 180 may include a gaseous or nongaseous precursor to a modifying material. The precursor to the modifying material may be in a liquid phase of the feed 180, a solid phase of feed 180, in a gaseous phase of feed 180 or a combination of the foregoing.

In addition to nongaseous precursors, feed 180 may also include other components. For example, feed 180 may include gases that are used to carry nongaseous components, such as a precursor, into the modifying zone 178. The modifying feed 180 may also include nongaseous components that are not precursors. As one example, feed 180 may include droplets of water, which are introduced into modifying zone 178 to absorb heat from the flowing stream and control the temperature within modifying zone 178. The foregoing are merely examples of the composition of feed 180 and are not intended to be limiting. In other embodiments, feed 180 may include components that have not been mentioned above, or include any combination of the components that have been mentioned above.

In one specific example of adding a modifying material in feed 180, a material may be introduced in feed 180 that prevents the nanoparticles from growing. The modifying material may be an organic material or an inorganic material that deposits on the surface of the nanoparticulates and prevents them from growing by modifying the surface of the nanoparticles so that when they collide they do not stick together and join. Some nonlimiting examples of ways in which the modifying material may prevent the nanoparticles from sticking together when colliding include, by depositing a material with higher melting point than the core material, thus preventing coalescence and growth of the core particles upon touching each other and by depositing an ionic material that will repel nanoparticles away from each other. It should be noted that the modifying material may increase the weight average particle size of the nanoparticles, because additional material is being added to their surface, but preferably does not significantly increase their size, or if the size is appreciatively increased the weight average particle still remains within a desired range. Moreover, the modifying material may, in addition to being useful to prevent the nanoparticles from growing, be useful in a final application of the nanoparticles. However, in other cases, the modifying material may only be used to prevent the nanoparticles from growing while in flame reactor 106 or agglomerating during or following collection and may be removed before the nanoparticles are used in a final application. The additional material may be removed from the nanoparticles in a variety of ways, such as for example dissolved by a solvent, vaporized, reacted away, or a combination of the foregoing, preferably with minimal effect on the properties of the nanoparticulates.

A compositional modification in the modifying zone 178, may include any modification of the composition of the nanoparticles. One such modification is to coat the particles with a coating material. Such coating may be accomplished in the particle modifying for example, by physical vapor deposition (PVD), chemical vapor deposition (CVD), gas-to-particle conversion, or conversion of a material of the nanoparticles at the particle surface.

It should also be noted that the method of the present invention is not limited to the embodiments described herein where feed 180 is used to introduce a modifying material into the flame reactor. In some instances a modifying material may already be present in the flowing stream when the flowing stream enters the modifying zone 178, such as for example, or by having been introduced into the flame reactor upstream from the modifying zone 178. In those cases, the modifying material may have the same purpose and functions as previously described above with respect to introducing the modifying material in feed 180. In other cases modifying materials may be introduced at other various locations in the flame reactor 106.

The residence times of the nanoparticles within the modifying zone 178 will vary depending on the desired modification of the nanoparticles. Typical residence times of the nanoparticles within the modifying zone 178 may be similar to the residence times within the secondary zone 134, discussed above.

In one specific embodiment of the present invention, the number concentration of nanoparticles in the flowing stream will be controlled so that it is at or below the characteristic number concentration when in the modifying zone 178 to inhibit further particle growth. Additionally, with such a low number concentration of the nanoparticles, modification may be performed at higher temperatures than if the number concentration were above the characteristic number concentration. The concentration of the modifying agent in the modifying zone should be controlled so that it is not high enough to cause separate particle formation from the modifying agent material and not too low so that there is not enough material to cover the surface of the core particles with at least a monolayer.

In other embodiments, the flame reactor may include more than one modifying zone, and the method will include more than one modifying nanoparticles step. Additionally, the modifying nanoparticles steps may be combined in any order with other steps or substeps that have previously been described or that are described below. Each modifying zone can be designed to provide desired mixing between the primary and modifying components to ensure uniform coverage. This arrangement can be used to produce multi-layered coatings on the core particles.

The ability to combine steps and substeps discussed above provides advantages in processing nanoparticles with complex materials (i.e., materials with more than two elements). Some examples of complex materials include mixed metal oxides such as phosphors, perovskites and glasses. One problem with processing nanoparticles that include complex materials is that oftentimes the component materials in the complex materials have very different properties such as vaporization temperatures (i.e., boiling points) that make formation of the nanoparticles in a single processing step difficult. For example, a first component of the complex material may have a very high vaporization temperature, while a second component a very low vaporization temperature. If processed in a single step, both components will be in a single gas phase while in a primary zone. As the temperature of the gas phase drops, the first component will nucleate and form nanoparticles, then as the temperature falls further, the second component will deposit on the first component and/or nucleate and form separate nanoparticles. Thus, the resulting nucleated nanoparticles will be nanoparticles with two phases (i.e., core/shell) and/or two separate nanoparticles of distinct compositions. Such materials may be of particular interest for catalyst applications.

In several embodiments of the present invention, a combination of substeps that include combinations of the growing step, quenching step and modification step may be used in various modes to process nanoparticles that include complex materials. One example includes introducing a first component, having a high-vaporization temperature, and a second component having a low-vaporization temperature into a primary zone of a flame reactor. As the nanoparticles begin to nucleate and form, they may be subjected to a quenching nanoparticles step that reduces the temperature of the nanoparticles to a temperature below the vaporization temperature of the second component in the form it exists in the vapor phase, causing the second component to come out of the vapor phase for inclusion in the nanoparticles, promoting inclusion of both the first component and the second component in the nanoparticles. Additionally, the quenching nanoparticles may be followed by a modifying nanoparticles where the nanoparticles are maintained at a temperature that will homogenize them to evenly distribute the first and second components throughout the nanoparticles.

D. Product Particle Quenching

In several aspects of the invention, the product particles (preferably nanoparticles) formed according to the present invention are quenched with a quenching medium in the primary zone of the reactor to reduce their temperature. The quenching step involves reducing the temperature of the nanoparticles by mixing a quench stream into the flowing stream in the flame reactor. The quench stream used to lower the temperature of the nanoparticles is at a lower temperature than the flowing stream, and when mixed with the flowing stream it reduces the temperature of the flowing stream, and consequently also the nanoparticles in the flowing stream. The quenching step may reduce the temperature of the nanoparticles by any desired amount. For example, the temperature of the flowing stream may be reduced at a rate of from about 500° C./s to about 40,000° C./s. In some applications, the temperature of the flowing stream may be reduced at a rate of about 30,000° C./s, or about 20,000° C./s, or about 10, 000° C./s, or about 5,000° C./s or about 1,000° C./s. In some embodiments, however, the temperature of the flowing stream should not be cooled at a rate such that contaminant materials would condense out of the gas phase in the flowing stream. Furthermore, the quenching rate should not be so high so as to prevent complete conversion of the precursor(s) to product particles.

FIG. 7 shows one embodiment of the flame reactor 106 that employs a quenching step. In addition to a primary zone 116, flame reactor 106 includes a quench zone 162. The quench zone 162 is immediately downstream of the primary zone 116. A feed 164 of quench medium is introduced into quench zone 162 for mixing with the flowing stream. Mixing the cooler quench medium into the flowing stream reduces the temperature of the flowing stream and any nanoparticles in the flowing stream. In one embodiment, the quenching is done in the primary zone. This is accomplished by introducing the quenching medium through the burner and around the precursor jet by properly designing the spray nozzle. This provides a cooling “envelope” that surrounds the main jet flame. Alternatively, the quenching medium can be introduced into the center of the burner and may be surrounded by the flame. This allows quenching of the flame from its core. Finally, a combination of the above two approaches can be used to cool the flame internally and externally.

The flame reactor 106 shown in FIG. 7 is only one embodiment of a flame reactor useful to implement the embodiment of a reactor employing a quench step. The flame reactor 106 shown in FIG. 7 shows the quench zone as within a same conduit configuration as the primary zone 116. However, in other embodiments, the quench zone may be in a conduit portion having a different shape, diameter or configuration than the primary zone 116. One example of a quench system that may be used as a quench zone to implement the method of the present invention is disclosed in U.S. Pat. No. 6,338,809, the entire contents of which are hereby incorporated by reference as if set forth herein in full.

The quench medium preferably comprises a quench gas. The quench gas used in the quenching step may be any suitable gas for quenching the nanoparticles. The quench gas may be nonreactive after introduction in the flame reactor and introduced solely for the purpose of reducing the temperature of the flowing stream. This might be the case for example, when it is desired to stop the growth of the nanoparticles through further collisions. The quenching step helps to stop further growth by diluting the flowing stream, thereby decreasing the frequency of particle collisions, and reducing the temperature, thereby reducing the likelihood that colliding particles will fuse together to form a new primary particle. When it is desired to stop further particle growth, the cooled stream exiting the quenching step should preferably be below a sintering temperature of the nanoparticulates. The cooled nanoparticles may then be collected—i.e., separated from the gas phase of the flowing stream. The quenching step may also be useful in retaining a particular property of the nanoparticles as they have formed and nucleated in the flowing stream. For example, if the nanoparticles have nucleated and formed with a particular phase that is desirable for use in a final application, the quenching step may help to retain the desirable phase that would otherwise recrystallize or transform to a different crystalline phase if not quenched. In other words, the quenching step may be useful to stop recrystallization of the nanoparticles if it is desirable to retain a particular crystal structure that the nanoparticles have nucleated and formed with. Alternatively, the quench gas may be nonreactive, but is not intended to stop nanoparticulate growth, but instead to only reduce the temperature to accommodate some further processing to occur at a lower temperature. As another alternative, the quench gas may be reactive in that it includes one or more components that is or becomes reactive in the flame reactor, such as reactive with material of the nanoparticles or with some component in the gas phase of the flowing stream in the flame reactor. As one example, the quench gas may contain a precursor for additional material to be added to the nanoparticles. The precursor may undergo reaction in the quench zone prior to contributing a material to the nanoparticulate, or may not undergo any reactions. In one specific example, the quench gas may contain oxygen, which reacts with a metal in the nanoparticles to promote production of a metal oxide in the nanoparticles or it may react with carbon contained in the nanoparticles to convert it to CO₂. The quenching may also help in production of metastable phases by kinetically controlling and producing a phase that is not preferred thermodynamically.

In addition to a gas phase, a quench medium introduced into the flame reactor may also include a nongaseous phase—e.g., a disperse particulate and/or disperse droplet phase, or liquid stream. The nongaseous phase may have any one of a variety of functions. For example, a nongaseous phase may contain precursor(s) for material(s) to be added to the nanoparticles. As another example, the quench gas may include a nongaseous phase that assists in lowering the temperature of the nanoparticulates, such as water droplets included to help consume heat and lower the temperature as the water vaporizes after introduction into the flame reactor. Other nongaseous phases may be used to assist lowering the temperature by consumption of heat through vaporization, however water is often preferred because of its low cost and high latent heat of vaporization.

In one aspect, the quenching step is followed by the growing step, which are each the same as discussed previously.

In another aspect, the quenching step is also a collection step. The feed 164 of quench medium is a liquid stream that simultaneously reduced the temperature and collects nanoparticles.

FIG. 7 also shows another embodiment of the flame reactor 106 that includes the quench zone 162 followed by the secondary zone 134. As shown in FIG. 7, the feed 120 including the nongaseous precursor, as discussed previously, is introduced into flame reactor 106 through burner 112 and into flame 114 in primary zone 116. Within primary zone 116 nanoparticles nucleate and form in the flowing stream. The flowing stream is then quenched in the quench zone 162 and then the nanoparticles are further grown in the secondary zone 134.

As one example referring to FIG. 7, the nanoparticles that form in the flowing stream may have a crystal structure that is useful for a final application and it is desirable to retain the crystal structure, which is otherwise lost if kept at the temperature of the flowing stream as it exits primary zone 116. The feed 164 of quench gas introduced into quench zone 162 cools the nanoparticles to a temperature that retains the desirable crystal structure. The secondary zone 134 downstream of the quench zone may then be used to further grow the nanoparticles while retaining the desired crystal structure.

As another example with reference to FIG. 7, the nanoparticles that nucleate and form in the flowing stream in primary zone 116 may be at a temperature at which they grow more quickly than desired. Quenching in the quench zone 162 temporarily stops or slows down the growth of the nanoparticles. After the quench zone 162, the nanoparticles flow into the secondary zone 134, where they may be controllably grown into a desired weight average particle size. Processing in the secondary zone may include, for example, addition of precursor to add additional material to the nanoparticles, or addition of heat to raise the temperature of the flowing stream to controllably recommence or accelerate the rate of particle growth through collisions.

In other aspects of the invention, there are multiple quench steps. For example, after the component from the nongaseous precursor is transferred through the gas phase, there may be a first quenching step, followed by a step of growing the nanoparticles, and a second quenching after the growing step. Thus, the method of the present invention may include one or two quenching steps or more than two quenching steps. In some embodiments, a quenching step may follow and/or precede other processing steps or substeps that have been previously described, or other steps not described herein the inclusion of which are not incompatible with other processing. The quenching step can occur as close to the flame as in the primary zone and as far from the flame as just before particle collection. In one embodiment, the quenching can take place at the flame itself by properly designing the burner to allow introduction of quench fluid around the main spray nozzle. This is preferred in cases where very high surface area amorphous materials are desirable. Additionally, in those embodiments that include more than one quenching step, the quench fluid used in each of the steps may be the same or different.

E. Product Particle Collection

In a preferred aspect of the invention, the product particles formed according to the processes of the invention are collected in a collecting nanoparticles step. The step of collecting the nanoparticles may be performed using any suitable methods or devices for separating solid particulate materials from gases.

In one embodiment, the nanoparticles are collected dry. In this embodiment, the collecting nanoparticles step may be performed for example, by using filters, such as a bag house, electrostatic precipitators or cyclones (especially for product particles larger than 500 nm). Bag house filters are a preferred device for performing the collecting nanoparticles step when the collecting nanoparticles step is performed to collect the nanoparticles in a dry state.

In other embodiments, the nanoparticles may be collected using a collection liquid. Any suitable device or method for separating solid particulates from gases using a collection liquid may be used with this embodiment of the present invention. Some nonlimiting examples of devices that may be used in this embodiment include venturi liquid scrubbers, which use a spray of collection liquid to separate nanoparticles from a gas. A wet wall may also be used to separate the nanoparticles from gases. The nanoparticulates may be passed through a wall of liquid, so that the nanoparticulates are captured by the liquid while the gases flow through the wet wall. In another embodiment, a wet electrostatic precipitator which works similar to the electrostatic precipitator previously discussed but includes a wet wall where the nanoparticles are collected is used to perform the collecting nanoparticles step. In yet another example, the nanoparticles may be collected in a liquid bath. The flowing stream containing the nanoparticles may be directed into or bubbled through a bath of collection liquid, where the nanoparticulate will be collected and the gases will flow through the liquid. These are intended only to be some nonlimiting examples of devices and methods by which the nanoparticles may be collected using a collecting liquid.

The use of a collecting liquid for performing the collecting nanoparticles step provides a variety of advantages. In one specific embodiment of the present invention, the collecting liquid used in collecting the nanoparticles step contains a surface modifying material. By the term “surface modifying material”, it is meant a material that interacts with the surface of the nanoparticles to change the properties of the surface of the nanoparticles. For example, the surface modifying material may deposit material onto the surface of the nanoparticles, bond surface groups to the nanoparticles or associate materials with the surface of the nanoparticles. In other cases, the surface modifying material may remove material from the nanoparticles, such as by removing surface groups or by etching material from the surface of the nanoparticulates. Additionally, the surface modifying material can be such that it creates a lyophobic, lyophillic, hydrophobic, or hydrophilic surface, thus, controlling compatibility and redispersion of the nanoparticle with a wide variety of solvents and substrates.

In one embodiment, the surface modifying material will interact with the nanoparticles to prevent the nanoparticles from sticking together, in other words, the surface modifying material allows the nanoparticles to remain in a disperse state while in the collection liquid and to easily disperse the nanoparticles for use in a final application. In some embodiments, the surface modifying material may deposit around the entire outside surface of the nanoparticles to prevent the nanoparticles from sticking together. In another embodiment, the surface modifying material may simply associate the surface of the nanoparticles in a way that keeps them dispersed. Some examples of surface modifying materials which may be included in the collection liquid include surfactants, such as ionic surfactants, non-ionic surfactants and zwitterionic surfactants and dispersants.

In some cases, the surface modifying material may not deposit onto the surface of the nanoparticles or associate with the surface of the nanoparticles but rather may remove material from the surface of the nanoparticles. For example, if there are materials that were present within the flame reactor that are deposited onto the surface of the nanoparticles, but it is desirable to remove those materials prior to use of the nanoparticles in a final application, the collection liquid may include a surface modifying material that removes the unwanted material from the surface of the nanoparticles. In other cases, it may be desirable for a final application to increase the specific surface area of the nanoparticles. In this embodiment, the collection liquid may include a surface modifying material that will slightly etch or remove material from the surface of the nanoparticles in order to increase the specific surface area of the nanoparticles. In yet another case, the collection liquid may include a material that will leach or remove in other ways, in whole or in part, the support particle material to produce highly porous component particles.

### EXAMPLES

The present invention is further described with reference to the following non-limiting examples.

### Example 1

### Supported Catalyst

The processes of the present invention may be used to produce supported catalysts with the catalytically active phase/component dispersed on the support particle. The catalyst with the composition Pt/Al₂O₃ (with Pt loading ranging from 0.1% wt to 5% wt) was produced from a solution of platinum acetyl acetone and aluminum diisopropoxide ethylacetoacetate dissolved in toluene. The solution was dispersed and introduced into the flame. Oxygen was used as a dispersion gas at 45 SLPM and the solution flow rate was 15 mL/min. The product consists of Pt nanoparticles dispersed on the surface of the transition alumina component. In this non-limiting example, the surface area of the final product was about 80 m²/g. The synthesized Pt/Al₂O₃ powders can be used as catalyst for hydrogenation, dehydrogenation, automotive emission reduction, and other applications.

### Example 2

### Aluminum Silicon Oxide Powders

The processes of the present invention may be used to produce mixed metal oxides with controlled morphology and composition. Octamethylcyclotetrasiloxane, as the silicon precursor, aluminum diisopropoxide ethylacetoacetate and aluminum organic compound (OMG), as the aluminum precursor mixed with toluene, were used as the precursor solutions for the synthesis of aluminum silicate powders. The aluminum and silicon weight percents in the precursor solution are 4.2 and 5.9, respectively. The precursor flow rate is varied from 10 to 15 ml/min, the dispersion oxygen is varied from 20 to 25 SLPM. The measured surface area of particles is 28 m²/gm when lower temperature reactor was used and 53 m²/gm when higher temperature reactor was used. The tunneling electron microscope (TEM) analysis and the scanning electron microscope (SEM) analysis observation of the powder shows that particles are non-agglomerated and are in the primary particles are in the size range of 50 to 200 nm. The TEM analysis shows that particles are amorphous in nature. The quasi-elastic light scattering analysis using Malvern instrument showed that intensity average particle size is 198.5 nm when lower temperature reactor was used, and the intensity average particle size of 249 nm when higher temperature reactor was used. The potential application of the synthesized powder is as a dental filler material and catalyst.

### Example 3

### Iron Copper Oxide Powder

Iron 2-ethylhexanoate and copper 2-ethylhexanoate mixed with toluene is used as the precursor solution for the synthesis of copper doped iron oxide powder. The metal weight percent of copper and iron in the precursor solution are 0.1 and 3.7 respectively. The precursor flow rate varied from 8 to 15 mL/min and dispersing oxygen flow rate varied from 25 to 28.7 SLPM. The surface area of particles varied from 37 to 150 m²/gm. The SEM analysis shows that primary particle size varies from 20 to 140 nm. The quasi-elastic light scattering analysis using Malvern instrument shows that intensity average particle size is 276.1 nm. The synthesized copper doped iron oxide powders can be used as a water gas shift catalyst and other catalyst applications.

Any feature described or claimed with respect to any disclosed implementation may be combined in any combination with any one or more other feature(s) described or claimed with respect to any other disclosed implementation or implementations, to the extent that the features are not necessarily technically incompatible, and all such combinations are within the scope of the present invention. Furthermore, the claims appended below set forth some nonlimiting combinations of features within the scope of the invention, but also contemplated as being within the scope of the invention are all possible combinations of the subject matter of any two or more of the claims, in any possible combination, provided that the combination is not necessarily technically incompatible.

What is claimed is:

1. A flame spray process, comprising the steps of:
(a) providing a first precursor medium comprising a first liquid vehicle, support particles distributed in the first liquid vehicle, and a nongaseous precursor to a component; and
(b) flame spraying the first precursor medium under conditions effective to form composite particles comprising the component dispersed on the support particles.

2. The process of claim 1, wherein the process further comprises the steps of:
(c) providing a second precursor medium comprising a second liquid vehicle and a precursor to the support particles;
(d) flame spraying the second precursor medium under conditions effective to form the support particles.

3. The process of claim 2, wherein steps (c) and (d) occur before steps (a) and (b).

4. The process of claim 1, wherein the composite particles comprise particles selected from the group consisting of catalyst particles, phosphor particles, and magnetic particles.

5. The process of claim 1, further comprising the steps of:
(c) collecting the composite particles; and
(d) dispersing the composite particles in a liquid medium.

6. The process of claim 5, further comprising the step of:
(e) applying the liquid medium onto a surface.

7. The process of claim 6, further comprising the step of:
(f) heating the surface to a maximum temperature below 500° C. to form at least a portion of an electronic component.

8. The process of claim 6, wherein the applying comprises ink jet printing or screen printing.

9. The process of claim 6, further comprising the step of:
(f) heating the surface to form at least a portion of a feature selected from the group consisting of a conductor, resistor, phosphor, dielectric, and a transparent conducting oxide.

10. The process of claim 9, wherein the feature comprises a ruthenate resistor or a titanate dielectric.

11. The process of claim 9, wherein the feature comprises a phosphor.

12. The process of claim 9, wherein the surface is heated to a maximum temperature below 500° C.

13. The process of claim 1, further comprising the steps of:
(c) collecting the composite particles; and
(d) forming an electrode from the composite particles.

14. The process of claim 13, wherein the electrode comprises a fuel cell electrode.

15. The process of claim 13, wherein the composite particles exhibit corrosion resistance.

16. The process of claim 1, wherein the composite particles maintain a surface area of at least 30 m²/g after exposure to air at 900° C. for 4 hours.

17. The process of claim 1, further comprising the steps of:
(c) collecting the composite particles; and
(d) forming an optical feature from the composite particles.

18. The process of claim 1, wherein the composite particles comprise a continuous or non-continuous coating of the component on the support particles.

19. The process of claim 1, wherein the composite particles comprise a population of nanoparticles comprising the component on the support particles.

20. The process of claim 19, wherein the population of nanoparticles, as formed, has a d50 value of less than about 500 nm.

21. The process of claim 20, wherein the d50 value has a standard deviation of less than about 2.2.

22. The process of claim 19, wherein the population of nanoparticles comprises less than about 5 volume percent particles having a particle size greater than 1 μm.

23. The process of claim 22, wherein step (b) occurs continuously for at least 4 hours.

24. The process of claim 22, wherein step (b) occurs continuously for at least 8 hours.

25. The process of claim 19, wherein the population of nanoparticles has a d95 value less than about 1000 nm.

26. The process of claim 19, wherein the support particles have an average particle size of less than about 10 μm.

27. The process of claim 1, wherein the support particles comprise a material selected from the group consisting of: a metal, a metal oxide, a metal salt, a nitride, a carbide, a sulfide and carbon.

28. The process of claim 1, wherein the component comprises a material selected from the group consisting of Ce, Zr, La, Al, Cu, Fe, Zn, CeO₂, ZrO₂, Al₂O₃, TiO₂, Fe₂O₃, Fe₃O₄, FeO, ZnO and SiO₂.

29. The process of claim 1, wherein at least 90 weight percent of the nongaseous precursor to the component in the first precursor medium is converted to the component.

30. The process of claim 1, wherein the process forms the composite particles at a rate of at least about 0.1 kg/hr.

31. The process of claim 1, wherein step (b) occurs in an enclosed flame spray reactor.

32. A process for forming nanoparticles, the process comprising the steps of:
(a) providing a precursor emulsion comprising a first liquid phase and a second liquid phase, wherein the first liquid phase comprises a first nongaseous precursor to a first component, and wherein the first and second liquid phases are not miscible in one another; and
(b) flame spraying the precursor emulsion under conditions effective to form a population of nanoparticles, wherein the nanoparticles comprise the first component.

33. The process of claim 32, wherein the nanoparticles comprise nanoparticles selected from the group consisting of catalyst nanoparticles, phosphor particles, and magnetic particles.

34. The process of claim 32, further comprising the steps of:
(c) collecting the nanoparticles; and
(d) dispersing the nanoparticles in a liquid medium.

35. The process of claim 34, further comprising the step of:
(e) applying the liquid medium onto a surface.

36. The process of claim 35, further comprising the step of:
(f) heating the surface to a maximum temperature below 500° C. to form at least a portion of an electronic component.

37. The process of claim 35, wherein the applying comprises ink jet printing or screen printing.

38. The process of claim 35, further comprising the step of:
(f) heating the surface to form at least a portion of a feature selected from the group consisting of a conductor, resistor, phosphor, dielectric, and a transparent conducting oxide.

39. The process of claim 38, wherein the feature comprises a ruthenate resistor or a titanate dielectric.

40. The process of claim 38, wherein the feature comprises a phosphor.

41. The process of claim 38, wherein the surface is heated to a maximum temperature below 500° C.

42. The process of claim 32, further comprising the steps of:
(c) collecting the nanoparticles; and
(d) forming an electrode from the nanoparticles.

43. The process of claim 42, wherein the electrode is a fuel cell electrode.

44. The process of claim 42, wherein the nanoparticles exhibit corrosion resistance.

45. The process of claim 32, wherein the nanoparticles maintain a surface area of at least 30 m²/g after exposure to air at 900° C. for 4 hours.

46. The process of claim 32, further comprising the steps of:
(c) collecting the nanoparticles; and
(d) forming an optical feature from the nanoparticles.

47. The process of claim 32, wherein the first liquid phase further comprises a first liquid vehicle.

48. The process of claim 47, wherein the second liquid phase comprises a second liquid vehicle.

49. The process of claim 48, wherein the first liquid vehicle has a first enthalpy of combustion and the second liquid vehicle has a second enthalpy of combustion, which is less than the first enthalpy of combustion.

50. The process of claim 48, wherein the first liquid vehicle has a first enthalpy of combustion and the second liquid vehicle has a second enthalpy of combustion, which is greater than the first enthalpy of combustion.

51. The process of claim 48, wherein the second liquid phase further comprises a second nongaseous precursor to a second component, and wherein the nanoparticles comprise the first component and the second component.

52. The process of claim 32, wherein the second liquid phase comprises a second nongaseous precursor to a second component, and wherein the nanoparticles comprise the first component and the second component.

53. The process of claim 52, wherein the second liquid phase further comprises a second liquid vehicle.

54. The process of claim 32, wherein the second liquid phase comprises a second liquid vehicle.

55. The process of claim 32, wherein the nanoparticles are hollow.

56. The process of claim 32, wherein a majority of the nanoparticles comprise a primary aggregate of primary nanoparticles.

57. The process of claim 32, wherein the first liquid vehicle has a first boiling point and the second liquid vehicle has a second boiling point, and wherein the absolute value of the difference between the first boiling point and the second boiling point is from about 10° C. to about 300° C.

58. The process of claim 32, wherein the volume ratio of the first liquid vehicle to the second liquid vehicle ranges from about 1% to about 99%.

59. The process of claim 32, wherein the second liquid phase further comprises a second nongaseous precursor to a second component, and wherein the nanoparticles formed in step (b) comprise the first component and the second component.

60. The process of claim 59, wherein each nanoparticle comprises a homogenous mixture of the first component and the second component.

61. The process of claim 32, wherein the population of nanoparticles, as formed, has a d50 value of less than about 300 nm.

62. The process of claim 61, wherein the d50 has a standard deviation of less than about 1.8.

63. The process of claim 32, wherein the population of nanoparticles comprises less than about 5 volume percent particles having a particle size greater than 1 μm.

64. The process of claim 63, wherein step (b) occurs continuously for at least 4 hours.

65. The process of claim 64, wherein step (b) occurs continuously for at least 8 hours.

66. The process of claim 32, wherein at least 90 weight percent of the first nongaseous precursor to the first component in the first liquid phase is converted to the first component in the nanoparticles.

67. The process of claim 32, wherein the process forms the nanoparticles at a rate of at least about 1 kg/hr.

68. The process of claim 32, wherein step (b) occurs in a enclosed flame spray reactor.

69. A flame spray process, comprising the steps of:
(a) providing a first precursor medium comprising a first liquid vehicle and particles of a first phase distributed in the first liquid vehicle; and
(b) flame spraying the first precursor medium under conditions effective to convert the particles of the first phase to particles of a second phase.

70. The process of claim 69, wherein the particles of the first phase comprise particles selected from the group consisting of catalyst particles, phosphor particles, and magnetic particles.

71. The process of claim 69, wherein the particles of the second phase comprise particles selected from the group consisting of catalyst particles, phosphor particles, and magnetic particles.

72. The process of claim 69, further comprising the steps of:
(c) collecting the particles of the second phase; and
(d) dispersing the particles of the second phase in a liquid medium.

73. The process of claim 72, further comprising the step of:
(e) applying the liquid medium onto a surface.

74. The process of claim 73, further comprising the step of:
(f) heating the surface to a maximum temperature below 500° C. to form at least a portion of an electronic component.

75. The process of claim 73, wherein the applying comprises ink jet printing or screen printing.

76. The process of claim 73, further comprising the step of:
(f) heating the surface to form at least a portion of a feature selected from the group consisting of a conductor, resistor, phosphor, dielectric, and a transparent conducting oxide.

77. The process of claim 76, wherein the surface is heated to a maximum temperature below 500° C.

78. The process of claim 76, wherein the feature comprises a ruthenate resistor or a titanate dielectric.

79. The process of claim 76, wherein the feature comprises a phosphor.

80. The process of claim 76, wherein the surface is heated to a maximum temperature below 500° C.

81. The process of claim 69, further comprising the steps of:
(c) collecting the particles of the second phase; and
(d) forming an electrode from the particles of the second phase.

82. The process of claim 81, wherein the electrode comprises a fuel cell electrode.

83. The process of claim 81, wherein the particles of the second phase exhibit corrosion resistance.

84. The process of claim 69, wherein the particles of the second phase maintain a surface area of at least 30 m²/g after exposure to air at 900° C. for 4 hours.

85. The process of claim 69, further comprising the steps of:
(c) collecting the particles of the second phase; and
(d) forming an optical feature from the particles of the second phase.

86. The process of claim 69, wherein the particles of the first phase comprise γ-alumina, and wherein the particles of the second phase comprise α-alumina.

87. The process of claim 69, wherein the particles of the first phase comprise anatase titania and wherein the particles of the second phase comprise rutile titania.

88. The process of claim 69, wherein the particles of the first phase are amorphous, and wherein the particles of the second phase are crystalline.

89. The process of claim 69, wherein the particles of the first phase comprise bhoemite alumina and wherein the particles of the second phase comprise gamma alumina.

90. The process of claim 69, wherein the particles of the first phase comprise separate phases of metal oxides, and wherein the particles of the second phase comprise a phase where the metal oxides are incorporated into a multicomponent crystal phase.

91. The process of claim 69, wherein the process further comprises the steps of:
(c) providing a second precursor medium comprising a second liquid vehicle and a precursor to the particles of the first phase;
(d) flame spraying the second precursor medium under conditions effective to form the particles of the first phase.

92. The process of claim 91, wherein steps (c) and (d) occur before steps (a) and (b).

93. The process of claim 69, wherein the particles of the first phase comprise a population of nanoparticles, as formed, having a d50 value of less than about 500 nm.

94. The process of claim 93, wherein the d50 value has a standard deviation of less than about 2.2.

95. The process of claim 93, wherein the population of nanoparticles comprises less than about 5 volume percent particles having a particle size greater than 1 μm.

96. The process of claim 95, wherein step (b) occurs continuously for at least 4 hours.

97. The process of claim 95, wherein step (b) occurs continuously for at least 8 hours.

98. The process of claim 93, wherein the population of nanoparticles has a d95 less than about 1000 nm.

99. The process of claim 93, wherein the population of nanoparticles has a d95 of less than about 800 nm.

100. The process of claim 93, wherein the population of nanoparticles has a d95 of less than about 500 nm.

101. The process of claim 69, wherein the particles of the first phase have an average particle size of less than about 500 nm.

102. The process of claim 69, wherein the particles of the first phase comprise a material selected from the group consisting of Ce, Zr, La, Al, Cu, Fe, Zn, CeO₂, ZrO₂, Al₂O₃, TiO₂, Fe₂O₃, Fe₃O₄, ZnO, and SiO₂.

103. The process of claim 69, wherein at least 90 weight percent of the particles of the first phase in the first precursor medium are converted to the particles of the second phase.

104. The process of claim 69, wherein the process forms the particles of the second phase at a rate of at least about 0.1 kg/hr.

105. The process of claim 69, wherein step (b) occurs in a enclosed flame spray reactor.

106. A method of making metal-containing nanoparticulates, the method comprising:
(a) introducing into a flame reactor heated by at least one flame a nongaseous precursor including a component for inclusion in a material of the nanoparticulates, the material comprising a metal; and
(b) forming the nanoparticulates, the forming comprising transferring substantially all of the component of the nongaseous precursor through a gas phase of a flowing stream in the flame reactor and growing in the flowing stream the nanoparticulates comprising the metal phase to a weight average particle size in a range having a lower limit of 1 nanometer and an upper limit of 500 nanometers.

107. The method of claim 106, wherein the nanoparticulates comprise nanoparticles selected from the group consisting of catalyst particles, phosphor particles, and magnetic particles.

108. The method of claim 106, further comprising the steps of:
(c) collecting the nanoparticulates; and
(d) dispersing the nanoparticulates in a liquid medium.

109. The method of claim 108, further comprising the step of:
(e) applying the liquid medium onto a surface.

110. The method of claim 109, further comprising the step of:
(f) heating the surface to a maximum temperature below 500° C. to form at least a portion of an electronic component.

111. The method of claim 109, wherein the applying comprises ink jet printing or screen printing.

112. The method of claim 109, further comprising the step of:
(f) heating the surface to form at least a portion of a feature selected from the group consisting of a conductor, resistor, phosphor, dielectric, and a transparent conducting oxide.

113. The process of claim 112, wherein the surface is heated to a maximum temperature below 500° C.

114. The method of claim 112, wherein the feature comprises a ruthenate resistor or a titanate dielectric.

115. The method of claim 112, wherein the feature comprises a phosphor.

116. The method of claim 106, further comprising the steps of:
(c) collecting the nanoparticulates; and
(d) forming an electrode from the nanoparticulates.

117. The method of claim 116, wherein the electrode comprises a fuel cell electrode.

118. The method of claim 116, wherein the nanoparticulates exhibit corrosion resistance.

119. The method of claim 106, wherein the nanoparticulates maintain a surface area of at least 30 m²/g after exposure to air at 900° C. for 4 hours.

120. The method of claim 106, further comprising the steps of:
(c) collecting the nanoparticulates; and
(d) forming an optical feature from the nanoparticulates.
